(19) United States
(12) Patent Application Publication
(10) Pub. No.: US 2014/0160469 A1
(43) Pub. Date: Jun. 12, 2014

(54) MEASUREMENT METHOD, MEASUREMENT APPARATUS, AND COMPUTER PROGRAM PRODUCT FOR A STEREOSCOPIC DISPLAY

(71) Applicant: Industrial Technology Research Institute, Hsinchu (TW)

(72) Inventors: Kuo-Chung Huang, Taichung City (TW); Yi-Heng Chou, Hsinchu City (TW); Ching-Chiu Liao, Hsinchu County (TW); Yu-Han Chen, Hsinchu City (TW); Hoang-Yan Lin, Keelung City (TW); Wen-Hui Chang, Taipei City (TW); Kuen Lee, Hsinchu City (TW); Lang-Chin Lin, Hsinchu City (TW)

(73) Assignee: Industrial Technology Research Institute, Hsinchu (TW)

(21) Appl. No.: 14/093,538

(22) Filed: Dec. 2, 2013

Related U.S. Application Data
(60) Provisional application No. 61/732,393, filed on Dec. 2, 2012.

(30) Foreign Application Priority Data
Jul. 15, 2013 (TW) 102125250

(51) Int. Cl. G01J 1/42

(52) U.S. Cl. CPC G01J 1/42
USPC 356/213

(57) ABSTRACT

A measurement method configured to measure a stereoscopic display includes: causing at least three different displaying positions to emit lights corresponding to a first viewing zone and measuring light intensities of the lights emitted by the displaying positions corresponding to the first viewing zone to respectively obtain at least three sets of first view light intensity distribution data, causing at least three different displaying positions to emit lights corresponding to the second viewing zone and measuring light intensities of the lights emitted by the displaying positions corresponding to the second viewing zone to respectively obtain at least three sets of second view light intensity distribution data, and calculating a set of total comprehensive distribution data according to the first and second view light intensity distribution data. A measurement apparatus and a computer program product are also provided.

### CROSS-REFERENCE TO RELATED APPLICATION

This application claims the priority benefits of U.S. provisional application Ser. No. 61/732,393, filed on Dec. 2, 2012 and Taiwan application serial no. 102125250, filed on Jul. 15, 2013. The entirety of each of the above-mentioned patent applications is hereby incorporated by reference herein and made a part of this specification.

### TECHNICAL FIELD

The technical field relates to a measurement method configured to measure a stereoscopic display, a measurement apparatus for a stereoscopic display, and a computer program product in a computer readable medium for measuring a stereoscopic display.

### BACKGROUND

A naked-eye stereoscopic display technology has been called for more and more markets, such as medical field, display, entertainment, education, military, design, advertisement and so on. However, attention to how to determine and describe characteristics of a developed stereoscopic display has not yet been drawn so far. Meanwhile, if viewing by using a well-manufactured auto-stereoscopic display but standing in a wrong position, no good viewing quality will be obtained. As a result, not only would blurry image be high possible to be seen, of which brightness, contrast and the images are incorrect, but also a sense of discomfort would be probably occur, which lead to loss of worth that a stereoscopic display should have. Accordingly, a technique for analyzing positions of measuring the stereoscopic display has become very important. Due to difference between parameters at design stage and of actual product outputs, how to identifying an optimal viewing position has become a major issue.

### SUMMARY

One of exemplary embodiments introduces a measurement method configured to measure a stereoscopic display. The method includes causing at least three different displaying positions of the stereoscopic display to emit lights corresponding to a first viewing zone and measuring a plurality of light intensities of the lights emitted by the at least three displaying positions corresponding to the first viewing zone to respectively obtain at least three sets of first view light intensity distribution data, wherein the at least three displaying positions have different abscissa values; causing the at least three different displaying positions of the stereoscopic display to emit lights corresponding to a second viewing zone and measuring a plurality of light intensities of the lights emitted by the at least three displaying positions corresponding to the second viewing zone to respectively obtain at least three sets of second view light intensity distribution data, wherein the at least three sets of first view light intensity distribution data and the at least three sets of second view light intensity distribution data are distribution data of a plurality of light intensity values respectively corresponding to positions where a plurality of values are located in the space in front of the stereoscopic display; calculating a set of total comprehensive distribution data according to the at least three sets of first view light intensity distribution data and the at least three sets of second view light intensity distribution data; and determining an optimal viewing position in the space in front of the stereoscopic display according to the set of total comprehensive distribution data.

One of exemplary embodiment introduces a measurement apparatus for measuring a stereoscopic display. The measurement apparatus includes a movable support unit, a light intensity meter, a signal generation device and a processing unit. The movable support unit includes a first carrying portion and a second carrying portion, wherein the second carrying portion is configured to move relatively to the first carrying portion to different positions and directions, and the first carrying portion is configured to carry the stereoscopic display. The light intensity meter is disposed on the second carrying portion, wherein when the second carrying portion moves relatively to the first carrying portion to different positions and directions, the light intensity meter measures a plurality of light intensities of lights emitted from different displaying positions of the stereoscopic display in different measuring positions or at different viewing angles. The signal generation device is configured to electrically connect with the stereoscopic display to output a test pattern signal to the stereoscopic display. The processing unit is electrically connected to the light intensity meter to calculate actual parameters of the stereoscopic display according to the plurality of light intensities measured by the light intensity meter.

One of exemplary embodiment introduces a computer program product in a computer readable medium for measuring a stereoscopic display. The computer program product includes first instructions, second instructions, third instructions and fourth instructions. The first instructions are configured to cause at least three different displaying positions of the stereoscopic display to emit lights corresponding to a first viewing zone and to measure a plurality of light intensities of the lights emitted by the at least three displaying positions corresponding to the first viewing zone to respectively obtain at least three sets of first view light intensity distribution data, wherein the at least three displaying positions have different abscissa values. The second instructions are configured to cause the at least three different displaying positions of the stereoscopic display to emit lights corresponding to a second viewing zone and to measure a plurality of light intensities of the lights emitted by the at least three displaying positions corresponding to the second viewing zone to respectively obtain at least three sets of second view light intensity distribution data. The at least three sets of first view light intensity distribution data and the at least three sets of second view light intensity distribution data are distribution data of a plurality of light intensity values respectively corresponding to positions where a plurality of values are located in the space in front of the stereoscopic display. The third instructions are configured to calculate a set of total comprehensive distribution data according to the at least three sets of first view light intensity distribution data and the at least three sets of second view light intensity distribution data. The fourth instructions are configured to determine an optimal viewing position in the space in front of the stereoscopic display according to the set of total comprehensive distribution data.

Several exemplary embodiments accompanied with figures are described in detail below to further describe the disclosure in details.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The accompanying drawings are included to provide further understanding, and are incorporated in and constitute a part of this specification. The drawings illustrate exemplary embodiments and, together with the description, serve to explain the principles of the disclosure.

FIG. 1A is a schematic view illustrating a stereoscopic display measured by utilizing a measurement method according to an embodiment of the disclosure.

FIG. 1B and FIG. 1C are schematic views illustrating the stereoscopic display depicted in FIG. 1A.

FIG. 2A is a flowchart illustrating a measurement method according to an embodiment of the disclosure.

FIG. 2B is a flowchart illustrating sub steps of step S130 depicted in FIG. 2A.

FIG. 3A illustrates a state of the stereoscopic display when performing step S110 depicted in FIG. 2A.

FIG. 3B illustrates a state of the stereoscopic display when performing step S120 depicted in FIG. 2A.

FIG. 4A illustrates a graph of the first view comprehensive light intensity distribution data calculated in step S132 of FIG. 2B.

FIG. 4B illustrates a graph of the second view comprehensive light intensity distribution data calculated in step S134 of FIG. 2B.

FIG. 5 illustrates a graph of the set of total comprehensive distribution data calculated in step S136 of FIG. 2B.

FIG. 6 is a flowchart illustrating the sub steps depicted in FIG. 2B according to another embodiment of the disclosure.

FIG. 7 illustrates a graph of the multiple view light intensity distribution data corresponding to the displaying position P2 which is calculated in step S132a of FIG. 6.

FIG. 8 is a flowchart illustrating the step S130 of FIG. 2A according to a modified embodiment.

FIG. 9A illustrates a distribution range of data having a uniformity greater than 80% among the at least three sets of second view light intensity distribution data that is obtained in step S120 depicted in FIG. 2A.

FIG. 9B illustrates a graph of adjusted second view comprehensive light intensity data corresponding to three sets of the adjusted second view light intensity distribution data of the displaying positions.

FIG. 10 is a flowchart illustrating the step S130 of FIG. 2A according to a modified embodiment.

FIG. 11A illustrates a distribution graph of the geometric means of the reciprocals of the selected first SCT values evaluated in step S132c of FIG. 10 respectively corresponding to the three displaying positions depicted in FIG. 1B.

FIG. 11B illustrates a graph of the first view light intensity crosstalk distribution data calculated in step S136c of FIG. 10.

FIG. 12 is a top view illustrating detailed structures of the stereoscopic display depicted in FIG. 1A.

FIG. 13A illustrates a graph of the first view comprehensive light intensity distribution data depicted in FIG. 2B when the light intensity is illuminance.

FIG. 13B illustrates a graph of the second view comprehensive light intensity distribution data depicted in FIG. 2B when the light intensity is illuminance.

FIG. 13C illustrates a graph of the set of total comprehensive distribution data depicted in FIG. 2A and FIG. 2B when the light intensity is illuminance.

FIG. 14 is a schematic view illustrating a measurement apparatus according to an embodiment of the disclosure.

### DETAILED DESCRIPTION OF DISCLOSED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

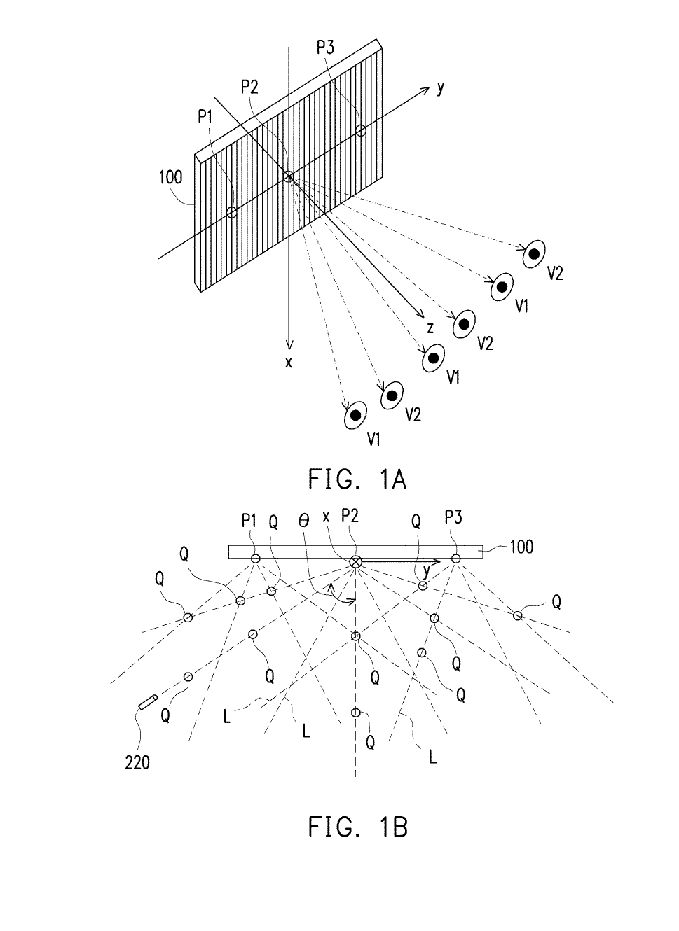

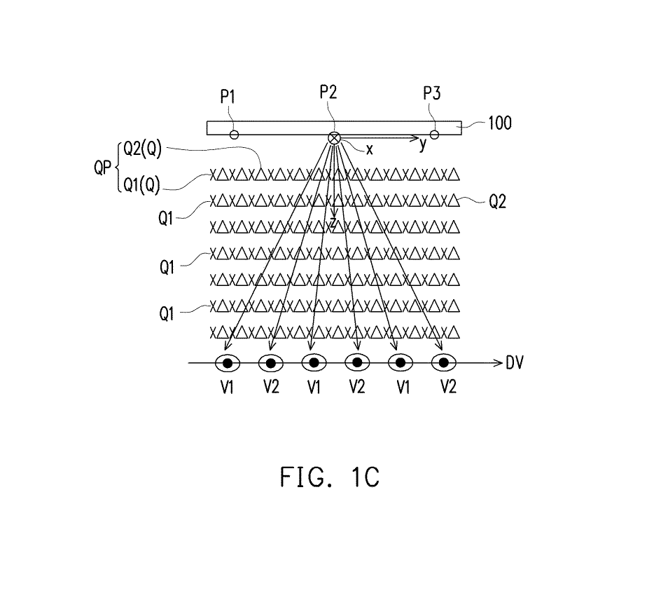

FIG. 1A is a schematic view illustrating a stereoscopic display measured by utilizing a measurement method according to an embodiment of the disclosure, and FIG. 1B and FIG. 1C are schematic top views illustrating the stereoscopic display depicted in FIG. 1A. Therein, FIG. 1B illustrates scenarios of the measurement performed in different view angles, and FIG. 1C illustrates positions where the values are located. Referring to FIG. 1A and FIG. 1B, the measurement method configured to measure the stereoscopic display is applicable to a stereoscopic display 100. In the present embodiment, the stereoscopic display 100 is an auto-stereoscopic display adapted to generate a plurality of viewing zones. In the present embodiment, the stereoscopic display 100 is a stereoscopic display with dual viewing zones and is adapted to generate a plurality of first viewing zones V1 and a plurality of second viewing zones V2 that repeatedly appear alternately. The stereoscopic display 100 is adapted to transmit a first image representing one certain viewing angle to the first viewing zones V1 and transmit a second image representing another view angle to the second viewing zone V2. When a user's left and right eyes are located in one first viewing zone V1 and one second viewing zone V2 that are adjacent to each other, the left eye views the first image, and the right eye views the second image. Accordingly, the first image is combined with the second image to form a three-dimensional (3D) image in the user's brain.

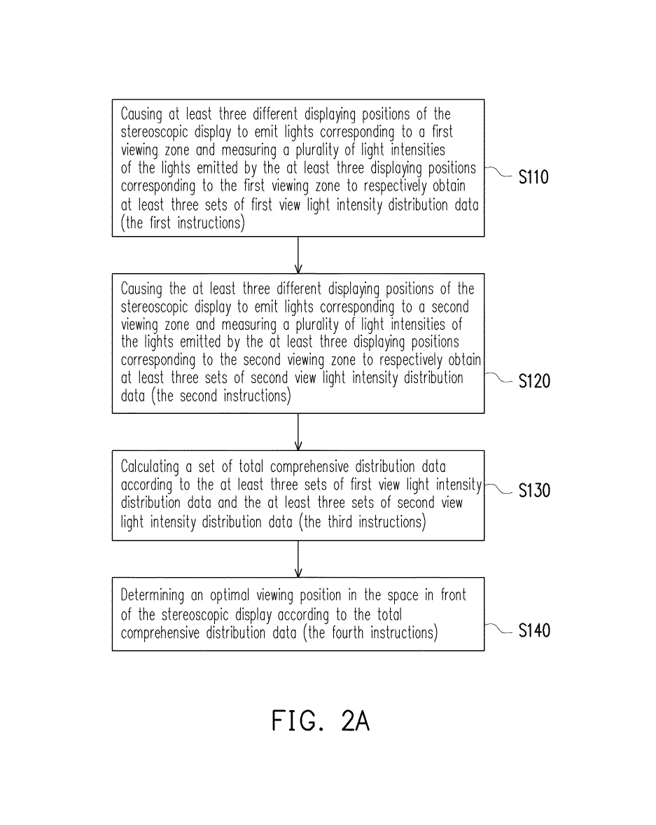

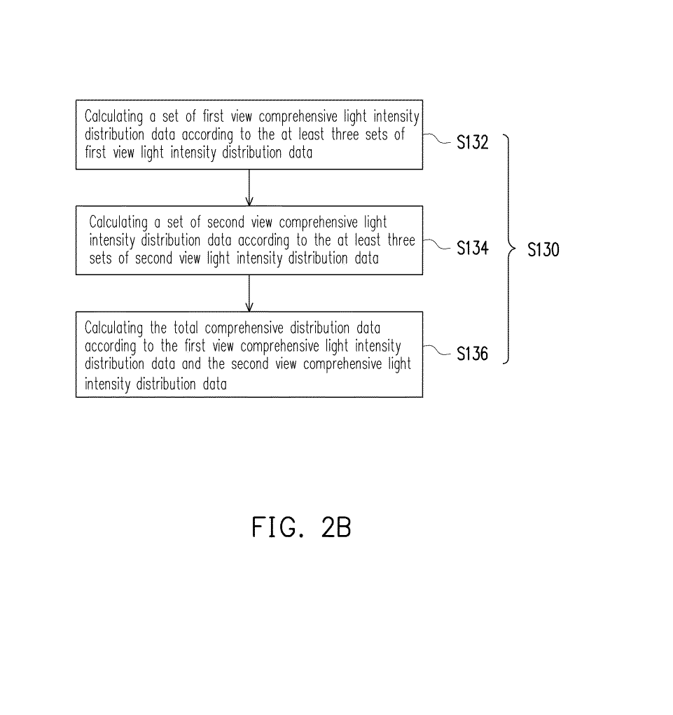

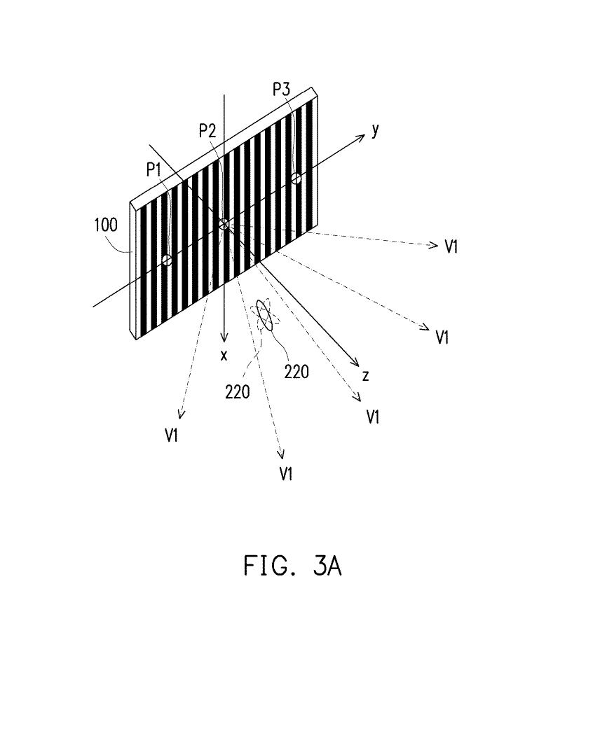

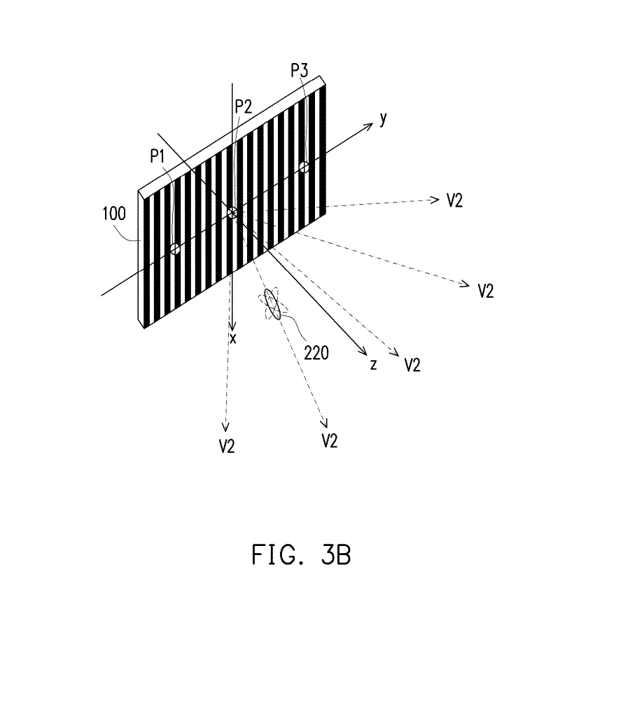

FIG. 2A is a flowchart illustrating a measurement method according to an embodiment of the disclosure. FIG. 2B is a flowchart illustrating sub steps of step S130 depicted in FIG. 2A. FIG. 3A illustrates a state of the stereoscopic display when performing step S110 depicted in FIG. 2A, and FIG. 3B illustrates a state of the stereoscopic display when performing step S120 depicted in FIG. 2A. Referring to FIG. 1B, FIG. 1C, FIG. 2A, FIG. 3A and FIG. 3B, the measurement method introduced in the present embodiment is adapted to measure the stereoscopic display 100. The measurement method includes steps as follows. First, step S110 is performed, where at least three different displaying positions (e.g., displaying positions P1, P2 and P3 illustrated in FIG. 3A) of the stereoscopic display 100 are caused to emit lights corresponding to the first viewing zones V1, and light intensities of the lights emitted by the at least three displaying positions P1, P2 and P3 corresponding to the first viewing zones V1 are measured to obtain at least three sets of first view light intensity distribution data. The at least three displaying positions P1, P2 and P3 respectively have different abscissa values, and a direction of the abscissa is defined as a direction of the stereoscopic display 100 being parallel with a connection line between two eyes of a viewer when the stereoscopic display 100 is set to provide the 3D image viewed by the viewer. For instance, the stereoscopic display 100 may be considered to be placed in the space defined by Cartesian coordinate formed by an x axis, a y axis and a z axis, and the x axis, the y axis and the z axis are perpendicular to each other. In the present embodiment, an original point of the Cartesian coordinate may be set in the displaying position P2, and a display surface of the stereoscopic display 100 may substantially fall on a xy plane or be substantially parallel to the xy plane. In the present embodiment, the displaying position P2 is, for example, a center position of the stereoscopic display 100 or a position of the stereoscopic display 100 located at any one point on a mean line perpendicular to the y axis.

Then, step S120 is performed, where at least three different displaying positions P1, P2 and P3 of the stereoscopic display 100 are caused to emit lights corresponding to the second viewing zones V2 and light intensities of the lights emitted by the at least three displaying positions P1, P2 and P3 corresponding to the second viewing zones V2 are measured to obtain at least three sets of second view light intensity distribution data. In the present embodiment, the at least three sets of first view light intensity distribution data and the at least three sets of second view light intensity distribution data are distribution data of a plurality of light intensity values respectively corresponding to positions Q (as shown in FIG. 1B and FIG. 1C) where a plurality of values are located in the space in front of the stereoscopic display 100.

In the present embodiment, the step of measuring the light intensity of the lights emitted by the at least three displaying positions P1, P2 and P3 respectively corresponding to the first viewing zones V1 and the second viewing zones V2 includes measuring the light intensity of the lights emitted by the at least three displaying positions P1, P2 and P3 respectively corresponding to the first viewing zones V1 and the second viewing zones V2 at different viewing angles θ (as shown in FIG. 1B) (for example, by using a light intensity meter 220 for the measurement at various viewing angles θ). The positions Q where the values are located are calculated by converting the view angles θ. To be more specific, positions on an extension line L extended from each of the displaying positions P1, P2 and P3 in each measured view angle θ may be served as the positions Q where the values are located, or intersections of the extension lines L may be selected as the positions Q where the values are located. In the present embodiment, a viewing angle θ may be defined as an inclination angle with respect to a normal of the display surface of the stereoscopic display 100.

In the present embodiment, the positions Q where the values of the at least three sets of first view light intensity distribution data and the at least three sets of second view light intensity distribution data are located may be defined as a plurality of position pairs QP. Each of the position pairs QP includes a first value position Q1 and second value position Q2. In the position pairs QP, distances between the first value positions Q1 and the corresponding second value positions Q2 are substantially the same. In other words, a distance between the first value position Q1 and the second value position Q2 in each of the position pairs QP is substantially the same.

In the present embodiment, the first value positions Q1 (i.e., positions labeled by a “X” mark in FIG. 1C) are located in different horizontal positions in the space in front of the stereoscopic display 100, and the horizontal direction is defined as a direction of the stereoscopic display 100 being parallel with a connection line between the eyes of the viewer when the stereoscopic display 100 is set to provide the 3D image viewed by the viewer. In the present embodiment, the horizontal positions are positions of the first value position Q1 perpendicularly projected on a horizontal plane (e.g., a yz plane), and the horizontal plane (e.g., the yz plane) includes an arrangement direction DV for arranging the first viewing zones V1 and the second viewing zones V2 and the normal of the stereoscopic display 100 (e.g., a straight line parallel to or coinciding with the z axis).

In the present embodiment, the second value position Q2 (i.e., positions labeled by a “Δ” mark in FIG. 1C) are located in different horizontal positions in the space in front of the stereoscopic display 100, and the horizontal positions are positions of the second value position Q2 perpendicularly projected on a horizontal plane (e.g., the yz plane).

In the present embodiment, a first value position Q1 in one of the position pairs QP and a second value position Q2 in another one of the position pairs QP may be the same position. In other words, in FIG. 1C, a position labeled by the “X” mark may coincide with a position labeled by the “Δ” mark in another position pair QP. That is, the positions labeled by the “X” mark and the “Δ” mark may share a same position Q. Alternatively, the first value positions Q1 and the second value positions Q2 in the position pairs QP may also not coincide with each other.

In the present embodiment, each of the light intensity values is, for example, luminance. In particular, the light intensity meter 220 is, for example, a luminance meter. In the present embodiment, three sets of luminance values may be measured using the luminance meter by respectively aiming at the displaying positions P1, P2 and P3 at the viewing angles. The luminance values measured using the luminance meter are not affected by distances being measured, and thus, the luminance values measured on any positions of the same extension line L (i.e., at the same viewing angle θ) are the same when the luminance meter is placed on the same extension line L. In other words, light intensity values (i.e., luminance values) of the first view light intensity distribution data corresponding to positions of different values on the same extension line L are the same, and light intensity values (i.e., luminance values) of the second view light intensity distribution data corresponding to positions of different values on the same extension line L are the same. By doing so, three sets of luminance distribution data (i.e., the first view light intensity distribution data) respectively corresponding to the displaying positions P1, P2 and P3 may be obtained. For instance, the first view light intensity distribution data corresponding to the displaying position P1 include the luminance value corresponding to each first value position Q1 and the corresponding y-coordinate and z-coordinate of the first value position Q1 obtained when measuring the displaying position P1.

Additionally, in the present embodiment, three sets of luminance values may be measured using the light intensity meter 220 (e.g. a luminance meter) by respectively aiming at the displaying positions P1, P2 and P3 at the viewing angles. By doing so, three sets of luminance distribution data (i.e., the second view light intensity distribution data) respectively corresponding to the displaying positions P1, P2 and P3 may be obtained. For instance, the second view light intensity distribution data corresponding to the displaying position P2 includes the luminance value corresponding to each first value position Q1 and the corresponding y-coordinate and z-coordinate of the second value position Q2 obtained when measuring the displaying position P2.

In the present embodiment, the at least three displaying positions P1, P2 and P3 are located on the same horizontal line of the stereoscopic display 100, and the horizontal line is substantially parallel to an arrangement direction DV of the first viewing zone V1 and the second viewing zone V2. In the present embodiment, the horizontal line is parallel to the connection line between the two eyes of the user when the user is able to view a 3D image. In FIG. 1A, the horizontal line is parallel to, for example, the y-axial direction. However, in other embodiments, at least two of the at least three displaying positions P1, P2 and P3 are located on different horizontal lines of the stereoscopic display 100. For example, the displaying positions P1, P2 and P3 are respectively located on three different horizontal lines of the stereoscopic display 100, the at least three displaying positions P1, P2 and P3 are respectively located on different vertical lines on the stereoscopic display 100, and the vertical lines are substantially perpendicular to an arrangement direction of the first viewing zone V1 and the second viewing zone V2, such as perpendicular to the y-axial direction.

In other embodiment, the stereoscopic display 100 may also be a switchable stereoscopic display 100 capable of being switched to be a stereoscopic display suitable for horizontal disposition (e.g., the stereoscopic display 100 as shown in FIG. 1A) or a stereoscopic display suitable for vertical disposition. When stereoscopic display is switched to be suitable for vertical disposition, the first viewing zone V1 and the second viewing zone V2 are arranged along the x-axial direction, and the horizontal direction is defined as the x-axial direction, that is, the direction of the connection line between the eyes of the viewer is also parallel to the x-axial direction.

Afterward, step S130 is performed, where a set of total comprehensive distribution data is calculated according to the at least three sets of first view light intensity distribution data and the at least three sets of second view light intensity distribution data. In the present embodiment, step S130 includes performing a corresponding multiplication operation on the at least three sets of first view light intensity distribution data and the at least three sets of second view light intensity distribution data so as to calculate a set of total comprehensive distribution data. For instance, step S130 may include performing a corresponding operation to evaluate geometric means of the at least three sets of first view light intensity distribution data and the at least three sets of second view light intensity distribution data so as to obtain the set of total comprehensive distribution data.

In the present embodiment, the step of performing the corresponding multiplication operation (or the corresponding operation to evaluate the geometric means) of the at least three sets of first view light intensity distribution data and the at least three sets of first view light intensity distribution data includes multiplying the light intensity values of the at least three sets of first view light intensity distribution data corresponding to the first value position Q1 with the light intensity values of the at least three sets of second view light intensity distribution data corresponding to the second value position Q1, which are in the same position pair QP, mapping the multiplication results (or the geometric means) to midpoint positions between the first value positions Q1 and the second value positions Q2 in the position pairs QP and further serving multiplication results (or geometric means) of the position pairs QP and corresponding midpoint positions as the set of total comprehensive distribution data.

In the present embodiment, step S130 may include steps S132, S134 and S136 (with reference to FIG. 2B) as follows. First, step S132 is performed, where a set of first view comprehensive light intensity distribution data is calculated according to the at least three sets of first view light intensity distribution data. Besides, step S134 is performed, where a set of second view comprehensive light intensity distribution data is calculated according to the at least three sets of second view light intensity distribution data. Then, step S136 is performed, where the set of total comprehensive distribution data is calculated according to the first view comprehensive light intensity distribution data and the second view comprehensive light intensity distribution data. In the disclosure, the sequence of performing step S132 and step S134 is not specially limited, and step S132 may be performed before step S134 or after step S134, or alternatively, steps S132 and S134 are simultaneously performed.

In the present embodiment, step S132 includes performing a multiplication operation on the at least three sets of first view light intensity distribution data and obtaining the first view comprehensive light intensity distribution data according to the multiplication result. For instance, a method for calculating the first view comprehensive light intensity distribution data according to the at least three sets of first view light intensity distribution data is to evaluate geometric means of the at least three sets of first view light intensity distribution data so as to obtain the first view comprehensive light intensity distribution data. To be more specific, a certain first value position Q1 (e.g., a certain (y, z) coordinate position) may correspond to three sets of first view light intensity (i.e., the light intensity values in the first view light intensity distribution data), such as L₁₁, L₁₂ and L₁₃, which are respectively measured when measuring the three displaying positions P1, P2 and P3. In this case, a first view comprehensive light intensity value L_{eq1} corresponding to the (y, z) coordinate in the first view comprehensive light intensity distribution data is

$$\sqrt[3]{{L}_{11} \times {L}_{12} \times {L}_{13}} .$$

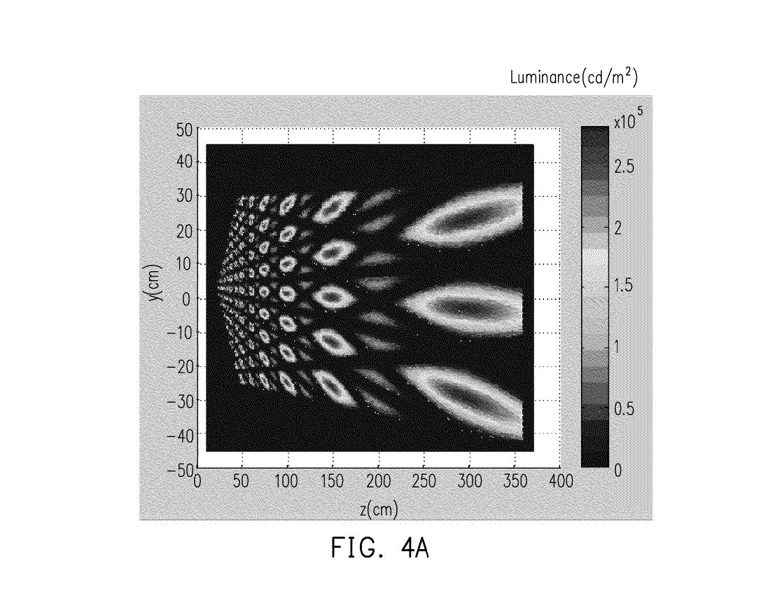

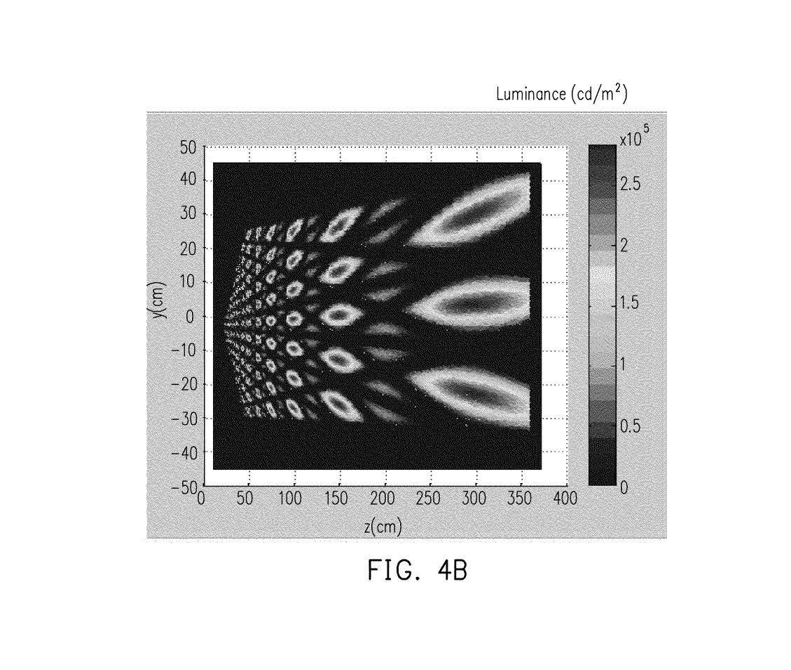

Additionally, the other first value positions Q1 are also calculated in the same way. Thus, the first view comprehensive light intensity value L_{eq1} located in all first value positions Q1 and the (y, z) coordinates of the first value positions Q1 corresponding thereto may construct the first view comprehensive light intensity distribution data, such as FIG. 4A, illustrating a graph of the first view comprehensive light intensity distribution data calculated in step S132 of FIG. 2B.

In the present embodiment, step S134 includes performing a multiplication operation on the at least three sets of second view light intensity distribution data and then obtaining the second view comprehensive light intensity value according to the multiplication result. For instance, a method for calculating the second view comprehensive light intensity value according to the at least three sets of second view light intensity distribution data is to evaluate geometric means of the at least three sets of second view light intensity distribution data so as to obtain the second view comprehensive light intensity value. To be more specific, a certain second value position Q2 (e.g., a certain (y, z) coordinate position) may correspond to three sets of second view light intensity (i.e., the light intensity values in the second view light intensity distribution data), such as L₂₁, L₂₂ and L₂₃, which are respectively measured when measuring the three displaying positions P1, P2 and P3. In this case, a second view comprehensive light intensity value L_{eq2} corresponding to the (y, z) coordinate in the second view comprehensive light intensity distribution data is

$$\sqrt[3]{{L}_{21} \times {L}_{22} \times {L}_{23}} .$$

Additionally, the other second value positions Q2 are also calculated in the same way. Thus, the second view comprehensive light intensity value L_{eq2} located in all second value positions Q2 and the (y, z) coordinates of the second value positions Q2 corresponding thereto may construct the second view comprehensive light intensity distribution data, such as FIG. 4B, illustrating a graph of the second view comprehensive light intensity distribution data calculated in step S134 of FIG. 2B.

In the present embodiment, step S136 includes performing a multiplication operation on the first view comprehensive light intensity distribution data and the second view comprehensive light intensity distribution data and then obtaining the set of total comprehensive distribution data according to the multiplication result. For instance, a method for calculating the set of total comprehensive distribution data according to the first view comprehensive light intensity distribution data and the second view comprehensive light intensity distribution data is to evaluate geometric means of the first view comprehensive light intensity distribution data and the second view comprehensive light intensity distribution data so as to obtain the set of total comprehensive distribution data.

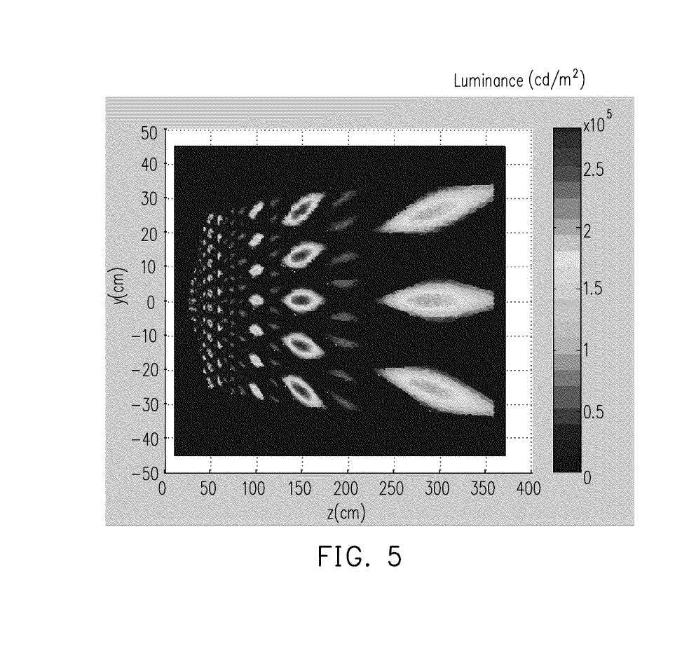

In the present embodiment, the operation of evaluating the geometric means of the first view comprehensive light intensity distribution data and the second view comprehensive light intensity distribution data includes converting coordinates of first measuring positions in the first view comprehensive light intensity distribution data and coordinates of second measuring positions in the second view comprehensive light intensity distribution data into a common coordinate and performing the operation of evaluating the geometric means of the first view comprehensive light intensity distribution data and the second view comprehensive light intensity distribution data according to the common coordinate. To be more specific, a first value position Q1 of each position pair QP may be considered as a left-eye position when the user watch the stereoscopic display 100 with the left eye, and a second value position Q2 of each position pair QP may be considered as a right-eye position when the user watch the stereoscopic display 100 with the right eye. An average of distances between binocular pupils of humans is about 6.5 cm, and accordingly, a distance between the first value position Q1 and the second value position Q2 in each position pair QP may be designed to be 6.5 cm. When the set of total comprehensive distribution data is calculated according to the first view comprehensive light intensity distribution data and the second view comprehensive light intensity distribution data, the (x, y) coordinate corresponding to the midpoint between the first value position Q1 and the second value position Q2 in each position pair QP is considered as a coordinate position of the common coordinate. Therefore, the (x, y) coordinates corresponding to all the midpoints may be considered as a plurality of viewing positions on the common coordinates, and each of the viewing positions corresponds to the midpoint of the binocular pupils of the user, i.e., approximately corresponding to the position between the eyebrows of the user. Moreover, a light intensity value L_{bi-eq1+2} in the set of total comprehensive distribution data corresponding to the (x, y) coordinate of the midpoint of each common coordinate (i.e., corresponding to each position pair QP) is \sqrt{L_{eq1}×L_{eq2}}, and values of L_{bi-eq1+2} of the midpoints on all the common coordinates and the corresponding (x, y) coordinates may construct the set of total comprehensive distribution data, such as FIG. 5, illustrating a graph of the set of total comprehensive distribution data calculated in step S136 of FIG. 2B.

In the above embodiment, the stereoscopic display having two viewing zones is illustrated for example. In other embodiments, when the stereoscopic display has three or more viewing zones, a geometric mean of comprehensive light intensity values of the viewing zones may be calculated so as to obtain a set of total comprehensive distribution data.

Thereafter, step S140 is performed, where an optimal viewing position in the space in front of the stereoscopic display 100 is determined according to the set of total comprehensive distribution data. In the present embodiment, step S140 includes determining the optimal viewing position based on positions corresponding to an extreme value in the set of total comprehensive distribution data. For instance, a method for determining the optimal viewing position based on the positions corresponding to the extreme value in the set of total comprehensive distribution data is serving a midpoint position between a first value position Q1 and a second value position Q2 (i.e., the midpoint position between the first value position Q1 and the second value position Q2 in one of the position pairs QP) corresponding to the extreme value of the set of total comprehensive distribution data as the optimal viewing position, and the optimal viewing position corresponds to the midpoint position of the user's eyes (i.e., the midpoint position between the binocular pupils, which is also the position between the user's eyebrows). Additionally, an extreme value is, for example, the absolute maximum value, which is also the maximum among all light intensity values L_{bi-eq1+2} throughout the set of total comprehensive distribution data. For instance, with reference to FIG. 5, the maximum among all the light intensity values L_{bi-eq1+2} falls on a position of (y,z)=(0, 146.25 cm). Besides, the measurement method of the present embodiment may further include serving a perpendicular distance between the optimal viewing position and the stereoscopic display (i.e., a distance parallel to the z-axis) as an optimal viewing distance (e.g., 146.25 cm as illustrated in FIG. 5).

In the measurement method of the present embodiment, the first view light intensity distribution data and the second view light intensity distribution data are utilized to calculate the set of total comprehensive distribution data, and then the optimal viewing position in the space in front of the stereoscopic display is determined according to the set of total comprehensive distribution data. Thus, by the measurement method of the present embodiment, not only the optimal viewing distance but also the optimal viewing position may be calculated. For example, in addition to the optimal viewing distance in the direction vertical to the display surface of the stereoscopic display 100, the optimal viewing position in the direction parallel to the display surface of the stereoscopic display 100 may be obtained. In this way, the optimal viewing position may still be accurately estimated even though design parameters of the stereoscopic display 100 have manufacturing errors. Meanwhile, whether there is any problem in the design parameters of the stereoscopic display 100 or whether the manufacturing error of the stereoscopic display 100 is excessively large and beyond a tolerable range may be judged according to the estimated optimal viewing position, and thereby, a feedback message in regard thereto is sent to the manufacturer of the stereoscopic display 100 to facilitate in future process improvement.

In another embodiment, the calculated optimal viewing position and positions neighboring therewith (e.g., neighboring positions having values of total comprehensive distribution data that are not much different from those of the set of total comprehensive distribution data of the optimal viewing position) may be considered as a movable space. When the position between the position between the user's eyebrows moves within the movable space, a correct and good 3D image still can be viewed.

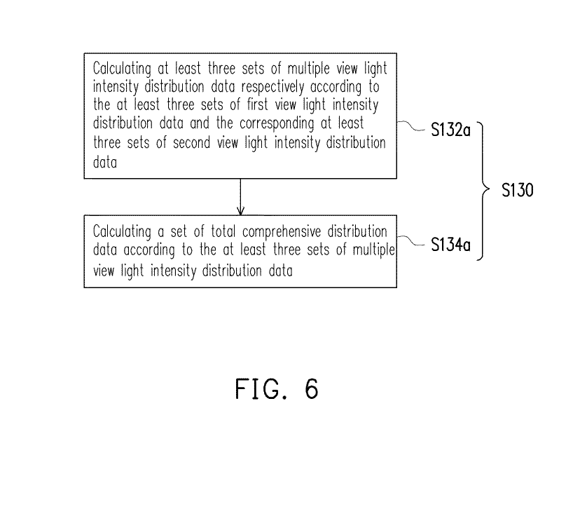

FIG. 6 is a flowchart illustrating the sub steps depicted in FIG. 2B according to another embodiment of the disclosure. With reference to FIG. 2A and FIG. 6, step S130 depicted in FIG. 2A may also be implemented by the manner depicted in FIG. 6. In the present embodiment, step S130 includes step S132a and step S134a. First, step S132a is performed, where at least three sets of multiple view light intensity distribution data (e.g., three sets of dual view light intensity distribution data) are calculated respectively according to the at least three sets of first view light intensity distribution data and the corresponding at least three sets of second view light intensity distribution data. In the present embodiment, the method of calculating the at least three sets of multiple view light intensity distribution data respectively according to the at least three sets of first view light intensity distribution data and the corresponding at least three sets of second view light intensity distribution data includes performing a multiplication operation on the at least three sets of first view light intensity distribution data and the corresponding at least three sets of second view light intensity distribution data and obtaining the at least three sets of multiple view light intensity distribution data according to the multiplication result. To be more specific, the method of calculating the at least three sets of multiple view light intensity distribution data respectively according to the at least three sets of first view light intensity distribution data and the corresponding at least three sets of second view light intensity distribution data includes evaluating geometric means of the at least three sets of first view light intensity distribution data and the corresponding at least three sets of second view light intensity distribution data so as to obtain the at least three sets of multiple view light intensity distribution data.

Additionally, in the present embodiment, the method of evaluating the geometric means of the at least three sets of first view light intensity distribution data and the corresponding at least three sets of second view light intensity distribution data so as to obtain the at least three sets of multiple view light intensity distribution data includes converting coordinates of first measuring positions in the at least three sets of first view light intensity distribution data and coordinates of second measuring positions in the at least three sets of second view light intensity distribution data into a common coordinate and performing the operation of evaluating the geometric means of the at least three sets of first view light intensity distribution data and the corresponding at least three sets of second view light intensity distribution data so as to obtain the at least three sets of multiple view light intensity distribution data.

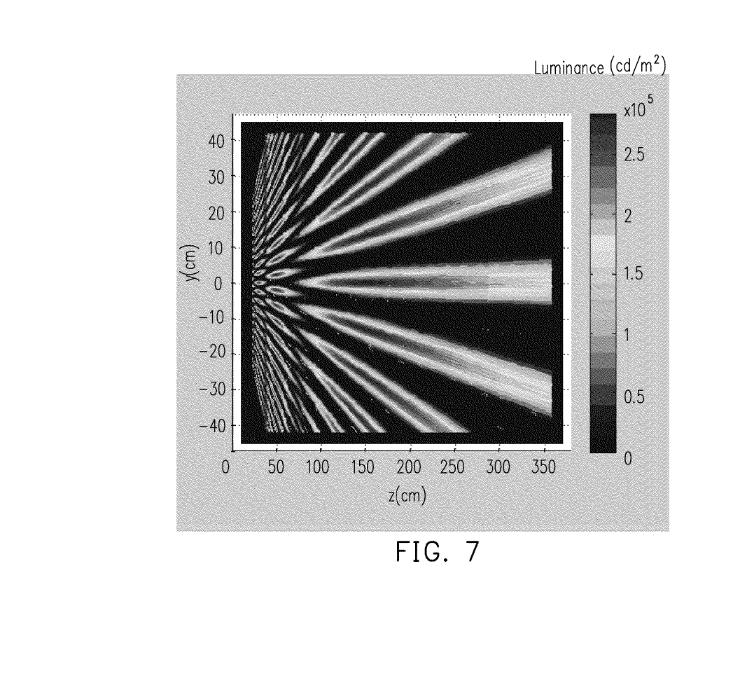

For instance, a certain first value position Q1 (e.g., a certain (y, z) coordinate position) may correspond to three sets of first view light intensity measured when measuring three displaying positions P1, P2 and P3, such as L₁₁, L₁₂ and L₁₃, a certain second value position Q2 (e.g., a certain (y, z) coordinate position) paired with the first value position Q1 (i.e., the first value position Q1 and the second value position Q2 belong to the same position pair QP) may correspond to three sets of second view light intensity measured when measuring three displaying positions P1, P2 and P3, such as L₂₁, L₂₂ and L₂₃, and thus, a multiple view light intensity distribution value in the multiple view light intensity distribution data corresponding to the displaying position P1 is \sqrt{L₁₁×L₂₁}, a multiple view light intensity distribution value in the multiple view light intensity distribution data corresponding to the displaying position P2 is \sqrt{L₁₂×L₂₂}, a multiple view light intensity distribution value in the multiple view light intensity distribution data corresponding to the displaying position P3 is \sqrt{L₁₃×L₂₃}. Moreover, each of the measuring positions corresponding to the values of \sqrt{L₁₁×L₂₁}, \sqrt{L₁₂×L₂₂} and \sqrt{L₁₃×L₂₃} is a midpoint between the first value position Q1 and the second value position Q2 in one of the position pairs QP that correspond to the measuring positions. FIG. 7 illustrates a graph of the multiple view light intensity distribution data corresponding to the displaying position P2 which is calculated in step S132a of FIG. 6.

Then, step S134a is performed, where a set of total comprehensive distribution data is calculated according to the at least three sets of multiple view light intensity distribution data. In the present embodiment, step S134a includes performing a multiplication operation on the at least three sets of multiple view light intensity distribution data and obtaining the set of total comprehensive distribution data according to the multiplication result. To be more specific, the method of calculating the set of total comprehensive distribution data according to the at least three sets of multiple view light intensity distribution data includes performing an operation of correspondingly evaluating geometric means of the at least three sets of multiple view light intensity distribution data so as to obtain the set of total comprehensive distribution data. For instance, a value in the set of total comprehensive distribution data corresponding to a midpoint of one of the position pairs QP is

$$\sqrt[3]{\sqrt{{L}_{11} \times {L}_{21}} \times \sqrt{{L}_{12} \times {L}_{22}} \times \sqrt{{L}_{13} \times {L}_{23}}} ,$$

and the graph of the set of total comprehensive distribution data is the same as that illustrated in FIG. 5.

In another embodiment, steps S132, S134 and S136 depicted in FIG. 2B or steps S132a and S134a depicted in FIG. 6 may combined as one step, and namely, a result of

$$\sqrt[6]{{L}_{11} \times {L}_{12} \times {L}_{13} \times {L}_{21} \times {L}_{22} \times {L}_{23}}$$

is calculated according the values of L₁₁, L₁₂, L₁₃, L₂₁, L₂₂ and L₂₃ measured in each measuring position pair OP so as to obtain values included in the set of total comprehensive distribution data, where a coordinate corresponding to each of the values is that of the midpoint of the corresponding position pair.

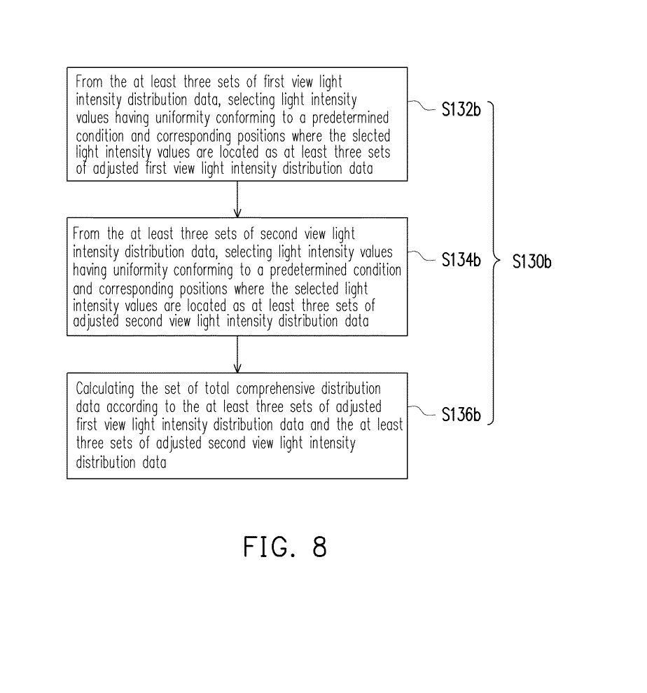

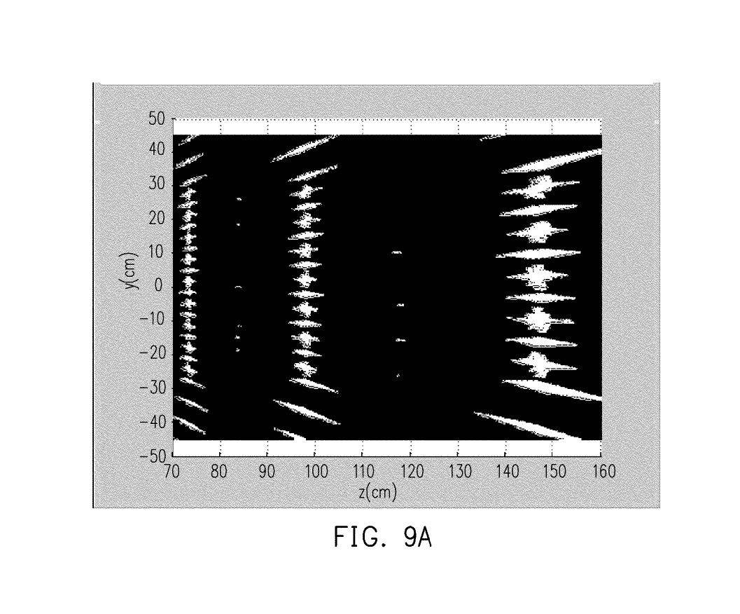

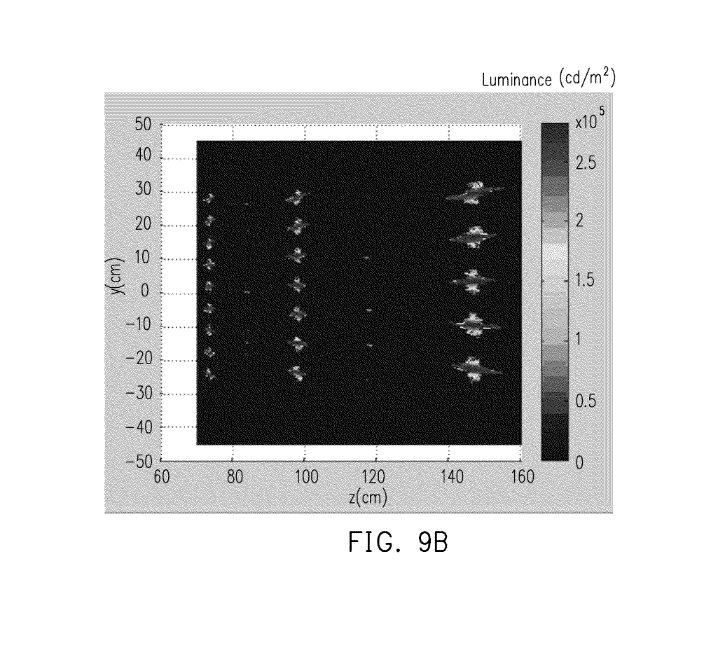

FIG. 8 is a flowchart illustrating the step S130 of FIG. 2A according to a modified embodiment. With reference to FIG. 2A and FIG. 8, step S130 depicted in FIG. 2A may also be replaced by step S130b depicted in FIG. 8. In the present embodiment, step S130b includes step S132b, step S134b and step S136b. First, in step S132b, from the at least three sets of first view light intensity distribution data, light intensity values having uniformity conforming to a predetermined condition and positions where values corresponding thereto are located are selected as three sets of adjusted first view light intensity distribution data. In the present embodiment, the aforementioned condition is set to be greater than a threshold, or set to be greater than and equal to a threshold. In addition, the uniformity is defined as a ratio or percentage of the minimum value divided by the maximum among the at least three light intensity values corresponding to the same first value position Q1. Then, step S134b is performed, where from the at least three sets of second view light intensity distribution data, light intensity values having uniformity conforming to a predetermined condition and positions where values corresponding thereto are located are selected as three sets of adjusted second view light intensity distribution data. Similarly, in the present embodiment, the predetermined condition is set to be greater than a threshold, or set to be greater than or equal to a threshold. In addition, the uniformity is defined as a ratio or percentage of the minimum value divided by the maximum among the at least three light intensity values corresponding to the same second value position Q2. For instance, FIG. 9A illustrates a distribution range of data having a uniformity greater than 80% among the at least three sets of second view light intensity distribution data that is obtained in step S120 depicted in FIG. 2A. In FIG. 9A, the white-color portion represents the second value positions Q2 corresponding to the light intensity values having the uniformity that conforms to the predetermined condition (e.g., being greater than 80%), while the black-color portion represents those that do not conform to the predetermined condition. In the present embodiment, the light intensity values having the uniformity less than or equal to 80% in the second view light intensity distribution data and positions Q where the corresponding values of those are located may be discarded. Meanwhile, the rest of the light intensity values and the positions where the corresponding values of those are located construct the adjusted second view light intensity distribution data, and the rest of the light intensity values conform to the condition that the uniformity thereof is greater than 80%. Likewise, in the present embodiment, the predetermined condition of the uniformity of the first view light intensity distribution data may be set to be greater than a threshold of 80%. However, in other embodiments, the threshold may be set as a value other than 80%.

Afterward, step S136b is performed, where a set of total comprehensive distribution data are calculated according to the at least three sets of adjusted first view light intensity distribution data and the at least three sets of adjusted second view light intensity distribution data. The implementation of step S136b is equivalent to respectively replacing the first view light intensity distribution data and second view light intensity distribution data in step S130 of FIG. 2A with the aforementioned adjusted first view light intensity distribution data and the adjusted second view light intensity distribution data, and the follow-up operation and process of calculating the set of total comprehensive distribution data is identical to those of the first view light intensity distribution data and the second view light intensity distribution data in step S130 of FIG. 2A. For instance, the operations in steps S132˜S136 depicted in FIG. 2B may be performed by respectively replacing the first view light intensity distribution data and the second view light intensity distribution data depicted in FIG. 2B with the adjusted first view light intensity distribution data and the adjusted second view light intensity distribution data and to calculate the set of total comprehensive distribution data. Alternatively, steps S132a and S134a depicted in FIG. 6 may be performed by replacing the first view light intensity distribution data and the second view light intensity distribution data depicted in FIG. 6 with the adjusted first view light intensity distribution data and the adjusted second view light intensity distribution data to calculate the set of total comprehensive distribution data. FIG. 9B illustrates a graph of adjusted second view comprehensive light intensity data obtained according to the three sets of adjusted second view light intensity distribution data corresponding to the displaying positions P1, P2 and P3 (i.e., the adjusted second view comprehensive light intensity data are obtained by an operation of correspondingly evaluating geometric means of the three sets of adjusted second view light intensity distribution data).

In the measurement method of the present embodiment, since the data is filtered in advance depending on whether the uniformity thereof conforms to the predetermined conditions, the set of total comprehensive distribution data calculated based on the filtered data may determine the optimal viewing position and optimal viewing distance in a more accurate way.

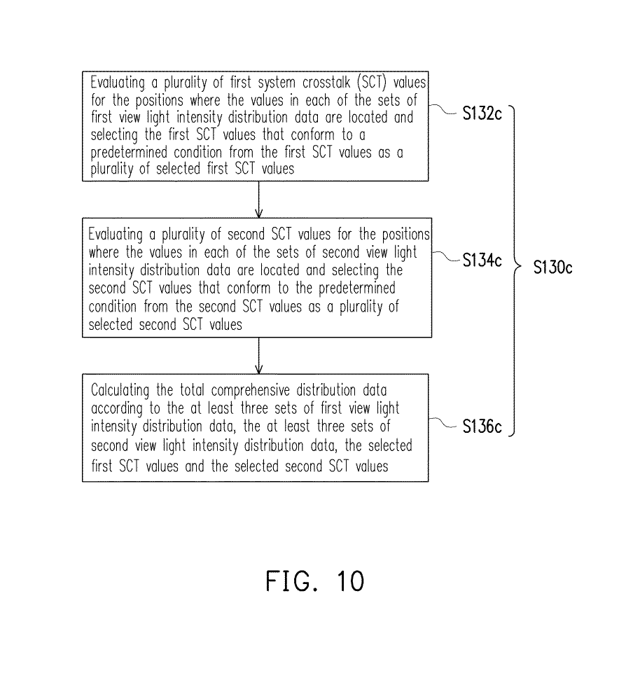

FIG. 10 is a flowchart illustrating the step S130 of FIG. 2A according to a modified embodiment. With reference to FIG. 2A and FIG. 10, step S130 depicted in FIG. 2A may be replaced by step S130c depicted in FIG. 10. In the present embodiment, step S130c includes step S132c, step S134c and step S136c. First, step S132c is performed, where a plurality of first system crosstalk (SCT) values is evaluated for the positions Q (i.e., the first value positions Q1) where the values are located in each first view light intensity distribution data, and the first SCT values that conform to a predetermined condition are selected from the first SCT values as a plurality of selected first SCT values. In the present embodiment, the evaluation of the SCT values may refer to the calculation on page 354 of Information Display Measurements Standard (IDMS) set up by the Society for Information Display (SID). To be more specific, a first SCT value X₁ of a certain first view light intensity distribution data is evaluated by an equation of X₁=(L_{1KW}−L_{1KK})/(L_{1WK}−L_{1KK}). In the present embodiment, for viewing the 3D image, the left eye of the user is suitable for being located in the first viewing zone, while the right eye is suitable for being located in the second viewing zone. L_{1KW} is a luminance obtained when measuring the displaying position P1, P2 or P3 in the first value position Q1 in a scenario where the first image corresponding to the first viewing zone V1 presents a black screen, and the second image corresponding to the second viewing zone V2 presents a while screen (e.g., a striped screen presented by the stereoscopic display 100 shown in FIG. 3B). L_{1WK} is a luminance obtained when measuring the displaying position P1, P2 or P3 in the first value position Q1 in a scenario where the first image corresponding to the first viewing zone V1 presents a black screen, and the second image corresponding to the second viewing zone V2 also presents a black screen (e.g., a full black screen presented by the stereoscopic display 100). L_{1WK} is a luminance obtained when measuring the displaying position P1, P2 or P3 in the first value position Q1 in a scenario where the first image corresponding to the first viewing zone V1 presents a white screen, and the second image corresponding to the second viewing zone V2 presents a black screen (e.g., a striped screen presented by the stereoscopic display 100 shown in FIG. 3A). The first SCT values corresponding to the displaying position P1 are evaluated based on the luminance of the displaying position P1 measured in the aforementioned manner and calculated by using the aforementioned method. Likewise, the first SCT values respectively corresponding to the displaying positions P2 and P3 are evaluated based on the luminance of the displaying positions P2 and P3 measured in the aforementioned manner and calculated by using the aforementioned method. Moreover, in the present embodiment, the aforementioned predetermined condition of the first SCT values is set to be less than a threshold or less than or equal to a threshold. For instance, among the first SCT values those that are less than a threshold of 5% are selected as the selected first SCT values, while those greater than or equal to 5% are discarded. However, in other embodiments, the threshold may also be set as a value other than 5%.

Afterward, step S134c is performed, where a plurality of second SCT values is evaluated for the positions Q (i.e., the second value position Q2) where the values are located in each second view light intensity distribution data, and the second SCT values that conform to the predetermined condition are selected from the second SCT values as a plurality of selected second SCT values. To be more specific, a second SCT value X₂ of a certain second view light intensity distribution data is evaluated by an equation of X₂=(L_{2WK}−L_{2KK})/(L_{2KW}−L_{2KK}). L_{2WK} is a luminance obtained when measuring the displaying position P1, P2 or P3 in the second value position Q2 in a scenario where the first image corresponding to the first viewing zone V1 presents a white screen, and the second image corresponding to the second viewing zone V2 presents a black screen (e.g., a striped screen presented by the stereoscopic display 100 shown in FIG. 3A). L_{2KK} is a luminance obtained when measuring the displaying position P1, P2 or P3 in the second value position Q2 in a scenario where the first image corresponding to the first viewing zone V1 presents a black screen, and the second image corresponding to the second viewing zone V2 presents a black screen (e.g., a full black screen presented by the stereoscopic display 100). L_{2KW} is a luminance obtained when measuring the displaying position P1, P2 or P3 in the second value position Q2 in a scenario where the first image corresponding to the first viewing zone V1 presents a black screen, and the second image corresponding to the second viewing zone V2 presents a white screen (e.g., a striped screen presented by the stereoscopic display 100 shown in FIG. 3B). The second SCT values corresponding to the displaying position P1 are evaluated based on the luminance of the displaying position P1 measured in the aforementioned manner and calculated by using the aforementioned method. Likewise, the second SCT values respectively corresponding to the displaying positions P2 and P3 are evaluated based on the luminance of the displaying positions P2 and P3 measured in the aforementioned manner and calculated by using the aforementioned method. Moreover, in the present embodiment, the aforementioned predetermined condition of the second SCT values is set to be less than a threshold or to be less than or equal to a threshold. For instance, among the second SCT values, those that are less than a threshold of 5% are selected as the selected second SCT values, while those greater than or equal to 5% are discarded. However, in other embodiments, the threshold may also be set as a value other than 5%.

Afterward, step S136c is performed, where the set of total comprehensive distribution data is calculated according to the at least three sets of first view light intensity distribution data, the at least three sets of second view light intensity distribution data, the selected first SCT values and the selected second SCT values. In the present embodiment, step S136c includes calculating the set of total comprehensive distribution data by serving a product of respectively multiplying the light intensity values corresponding to positions where the values having the first SCT values conforming to the predetermined condition are located in each first view light intensity distribution data with reciprocals of the selected first SCT values as a set of first view light intensity crosstalk distribution data, by serving a product of respectively multiplying a product of respectively multiplying the light intensity values corresponding to positions where the values having the second SCT values conforming to the predetermined condition are located in each second view light intensity distribution data with reciprocals of the selected second SCT values as a set of second view light intensity crosstalk distribution data and calculating the set of total comprehensive distribution data according to the at least three sets of first view light intensity crosstalk distribution data and the at least three sets of second view light intensity crosstalk distribution data.

To be more specific, a certain first value position Q1 may correspond to three sets of first view light intensity respectively measured when measuring the three displaying positions P1, P2 and P3, such as L₁₁, L₁₂ and L₁₃ and may correspond to three sets of evaluated SCT values, X₁₁, X₁₂, X₁₃. Then, from the first SCT values X₁₁, X₁₂ and X₁₃ measured in the first value position Q1, those having values less than 5% are selected as the selected first SCT values X₁₁, X₁₂, X₁₃, while the rest of the first SCT values X₁₁, X₁₂ and X₁₃ are discarded. Thereafter, from the sets of first view light intensity L₁₁, L₁₂ and L₁₃, those corresponding to the selected first SCT values X₁₁, X₁₂, X₁₃ are selected as a set of selected first view light intensity L₁₁, L₁₂ and L₁₃. Additionally,

$$\frac{{L}_{11}}{{X}_{11}}$$

corresponding to all the first value positions Q1 is served as the first view light intensity crosstalk distribution data corresponding to the displaying position P1,

$$\frac{{L}_{12}}{{X}_{12}}$$

corresponding to all the first value positions Q1 is served as the first view light intensity crosstalk distribution data corresponding to the displaying position P2, and

$$\frac{{L}_{13}}{{X}_{13}}$$

corresponding to all the first value positions Q1 is served as the first view light intensity crosstalk distribution data corresponding to the displaying position P3.

On the other hand, a certain second value position Q2 may correspond to three sets of second view light intensity respectively measured when measuring the three displaying positions P1, P2 and P3, such as L₂₁, L₂₂ and L₂₃ and may correspond to three sets of evaluated SCT values, X₂₁, X₂₂ and X₂₃. Then, from the SCT values X₂₁, X₂₂ and X₂₃ measured in the second value position Q2, those having values less than 5% are selected as the second SCT values X₂₁, X₂₂, X₂₃, while the rest of the second SCT values X₂₁, X₂₂, X₂₃ are discarded. Thereafter, from the sets of second view light intensity L₂₁, L₂₂ and L₂₃, those corresponding to the selected second SCT values X₂₁, X₂₂ and X₂₃ are selected as a set of selected second view light intensity L₂₁, L₂₂ and L₂₃. Additionally,

$$\frac{{L}_{21}}{{X}_{21}}$$

corresponding to all the second value positions Q2 is served as the second view light intensity crosstalk distribution data value corresponding to the displaying position P1,

$$\frac{{L}_{22}}{{X}_{22}}$$

corresponding to all the second value positions Q2 is served as the second view light intensity crosstalk distribution data corresponding to the displaying position P2, and

$$\frac{{L}_{23}}{{X}_{23}}$$

corresponding to all the second value positions Q2 is served as the second view light intensity crosstalk distribution data corresponding to the displaying position P3.

Afterwards, a result of

$$\sqrt[6]{\frac{{L}_{11}}{{X}_{11}} \times \frac{{L}_{12}}{{X}_{12}} \times \frac{{L}_{13}}{{X}_{13}} \times \frac{{L}_{21}}{{X}_{21}} \times \frac{{L}_{22}}{{X}_{22}} \times \frac{{L}_{23}}{{X}_{23}}}$$

is calculated, a coordinate position corresponding to each result is a midpoint coordinate between the first value position Q1 and the second value position Q2 in each position pair QP. Additionally, in the first view light intensity crosstalk distribution data and the second view light intensity crosstalk distribution data, values of the first and the second view light intensity crosstalk distribution data corresponding to the first value positions Q1 and the second value positions Q2 which correspond to the discarded first SCT values X₁₁, X₁₂ and X₁₃, the discarded second SCT values X₂₁, X₂₂ and X₂₃, the discarded first view light intensity L₁₁, L₁₂ and L₁₃ and the discarded second view light intensity L₂₁, L₂₂ and L₂₃ may be set be 0.

All results of

$$\sqrt[6]{\frac{{L}_{11}}{{X}_{11}} \times \frac{{L}_{12}}{{X}_{12}} \times \frac{{L}_{13}}{{X}_{13}} \times \frac{{L}_{21}}{{X}_{21}} \times \frac{{L}_{22}}{{X}_{22}} \times \frac{{L}_{23}}{{X}_{23}}}$$

corresponding to all the midpoint positions construct the set of total comprehensive distribution data. The way for calculating the results of

$$\sqrt[6]{\frac{{L}_{11}}{{X}_{11}} \times \frac{{L}_{12}}{{X}_{12}} \times \frac{{L}_{13}}{{X}_{13}} \times \frac{{L}_{21}}{{X}_{21}} \times \frac{{L}_{22}}{{X}_{22}} \times \frac{{L}_{23}}{{X}_{23}}}$$

may vary in calculation according to the commutative property of multiplication and the index commutative property. For instance, results of

$$\sqrt[3]{\frac{{L}_{11}}{{X}_{11}} \times \frac{{L}_{12}}{{X}_{12}} \times \frac{{L}_{13}}{{X}_{13}}} and \sqrt[3]{\frac{{L}_{21}}{{X}_{21}} \times \frac{{L}_{22}}{{X}_{22}} \times \frac{{L}_{23}}{{X}_{23}}}$$

may be first respectively calculated, the two results may be multiplied, and then the square root of the product may be calculated. Or, results of

$$\sqrt{\frac{{L}_{11}}{{X}_{11}} \times \frac{{L}_{21}}{{X}_{21}}} , \sqrt{\frac{{L}_{12}}{{X}_{12}} \times \frac{{L}_{22}}{{X}_{22}}} and \sqrt{\frac{{L}_{13}}{{X}_{13}} \times \frac{{L}_{23}}{{X}_{23}}}$$

may be first respectively calculated, the three results may be multiplied, and then the cube root of the product may be calculated. Alternatively, results of

$$\sqrt[3]{{L}_{11} \times {L}_{12} \times {L}_{13}} , \sqrt[3]{{L}_{21} \times {L}_{22} \times {L}_{23}} , \sqrt[3]{\frac{1}{{X}_{11}} \times \frac{1}{{X}_{12}} \times \frac{1}{{X}_{13}}} and \sqrt[3]{\frac{1}{{X}_{21}} \times \frac{1}{{X}_{22}} \times \frac{1}{{X}_{23}}}$$

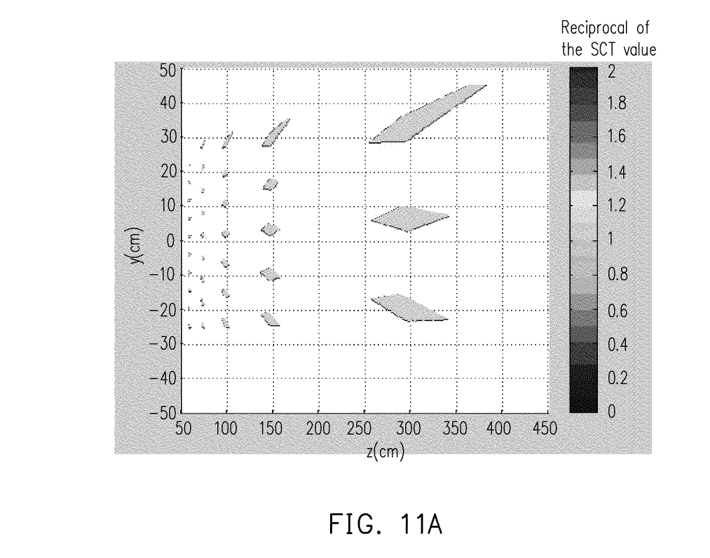

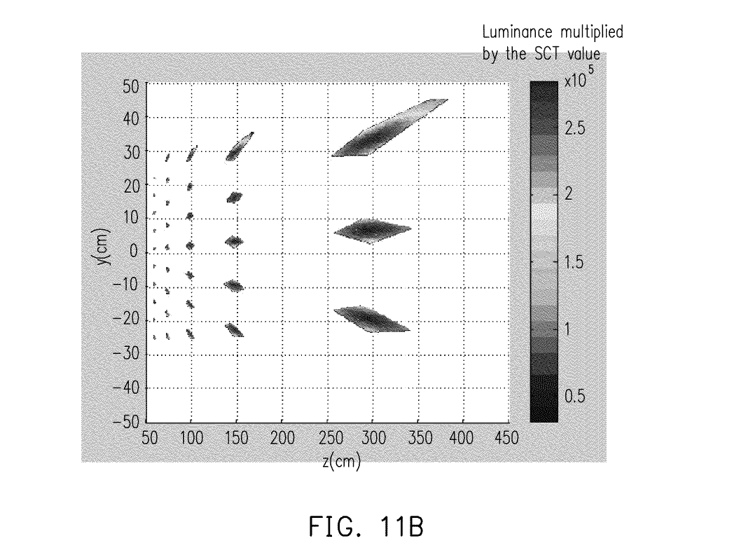

may be first respectively calculated, the four results may be multiplied, and then the square root of the product may be calculated. FIG. 11A illustrates a distribution graph of the geometric means of the reciprocals of the selected first SCT values obtained in step S132c of FIG. 10 respectively corresponding to the three displaying positions P1, P2, P3 depicted in FIG. 1B, i.e., a distribution graph of

$$\sqrt[3]{\frac{1}{{X}_{11}} \times \frac{1}{{X}_{12}} \times \frac{1}{{X}_{13}}} ,$$

and FIG. 11B illustrates a graph of the first view light intensity crosstalk distribution data calculated in step S136c of FIG. 10, i.e., a distribution graph of

$$\sqrt[3]{\frac{{L}_{11}}{{X}_{11}} \times \frac{{L}_{12}}{{X}_{12}} \times \frac{{L}_{13}}{{X}_{13}}} .$$

Referring to FIG. 1B, FIG. 2A and FIG. 2B again, in another embodiment, step S132 of FIG. 2B may include raising at least one of the at least three sets of first view light intensity distribution data to the power greater than 1 to obtain at least one set of weighted first view light intensity distribution data, raising at least one of the at least three sets of second view light intensity distribution data to the power greater than 1 to obtain at least one set of weighted second view light intensity distribution data, wherein the displaying positions P1, P2 and P3 corresponding to the weighted second view light intensity distribution data and the displaying positions P1, P2 and P3 corresponding to the weighted first view light intensity distribution data are substantially the same, and multiplying the at least one set of weighted first view light intensity distribution data, the rest of the first view light intensity distribution data, the at least one set of weighted second view light intensity distribution data and the rest of the second view light intensity distribution data so as to calculate the set of total comprehensive distribution data. In the present embodiment, after multiplying the at least one set of weighted first view light intensity distribution data, the rest of the first view light intensity distribution data, the at least one set of weighted second view light intensity distribution data and the rest of the second view light intensity distribution data, the Kth root of the product may be calculated to obtain the set of total comprehensive distribution data, wherein K is a sum of the total power of the rest of the first view light intensity distribution data, the total power of the at least one set of weighted first view light intensity distribution data, the total power of the rest of the second view light intensity distribution data and the total power of the at least one set of weighted second view light intensity distribution data.

For instance, step S132 of FIG. 2B may include raising at least one of the at least three sets of first view light intensity distribution data to the power greater than 1 to obtain at least one set of weighted first view light intensity distribution data, multiplying the at least one set of weighted first view light intensity distribution data with the rest of the first view light intensity distribution data to obtain a set of first product data, and calculating the Mth root of the first product data to obtain the first view comprehensive light intensity distribution data, wherein M is a sum of the total power of the first view light intensity distribution data plus the total power of the at least one set of weighted first view light intensity distribution data. In the present embodiment, step S132 of FIG. 2B may include raising one of the at least three sets of first view light intensity distribution data to the power of N to obtain a set of weighted first view light intensity distribution data, wherein N is greater than or equal to 2, multiplying the weighted first view light intensity distribution data with the rest of the first view light intensity distribution data to obtain a set of first product data, and calculating the Mth root of the first product data to obtain the first view comprehensive light intensity distribution data, wherein M is a sum of the number of the sets of first view light intensity distribution data plus N. For instance, in order to increase the weight of the effect produced by the displaying position P2, a result of

$$\sqrt[4]{{L}_{11} \times {L}_{12} \times {L}_{12} \times {L}_{13}}$$

may be calculated, and results corresponding to all the first value positions Q1 may be served as the first view comprehensive light intensity distribution data. In this case, N=2, i.e., a square of L₁₂ is calculated, which is also L₁₂×L₁₂ as expressed above. Additionally, values of the rest of the first view light intensity distribution data are L₁₁ and L₁₃. Thus, a value of the first product data is L₁₁×L₁₂×L₁₂×L₁₃. Further, in this case, the number of the sets of the rest of the first view light intensity distribution data is 2 (i.e., the data constructed by L₁₁ and that constructed by L₁₃ are 2 sets in total), N=2, and thus, M=2+2=4. Accordingly, the result of

$$\sqrt[4]{{L}_{11} \times {L}_{12} \times {L}_{12} \times {L}_{13}}$$

is obtained from the 4^{th} root of the value of the first product data.

Moreover, step S134 of FIG. 2B may include raising at least one of the at least three sets of second view light intensity distribution data to the power greater than 1 to obtain at least one set of weighted second view light intensity distribution data, wherein the displaying positions corresponding to the weighted second view light intensity distribution data and the displaying positions corresponding to the weighted first view light intensity distribution data are substantially the same; multiplying the at least one set of weighted second view light intensity distribution data with the rest of the second view light intensity distribution data to obtain a set of second product data; and calculating the Mth root of the second product data to obtain the second view comprehensive light intensity data, wherein M is a sum of the total power of the second view light intensity distribution data plus the total power of the at least one set of weighted second view light intensity distribution data, i.e., K=M+M as expressed above. In the present embodiment, step S134 of FIG. 2B may include raising one of the at least three sets of second view light intensity distribution data to the power of N to obtain a set of weighted second view light intensity distribution data, wherein the displaying positions corresponding to the weighted second view light intensity distribution data and the displaying positions corresponding to the weighted first view light intensity distribution data are substantially the same; multiplying the weighted second view light intensity distribution data with the rest of the second view light intensity distribution data to obtain a set of second product data; and calculating the Mth root of the second product data to obtain the second view comprehensive light intensity data, where in M is a sum of the number of the sets of second view light intensity distribution data plus N. For instance, a result of

$$\sqrt[4]{{L}_{21} \times {L}_{22} \times {L}_{22} \times {L}_{23}}$$

may be calculated and results corresponding to all the second value positions Q2 may be served as the second view comprehensive light intensity data.

After performing step S132 and step S134 of the method described above where the weighted first view comprehensive light intensity distribution data and the weighted second view comprehensive light intensity data are respectively calculated through a weighting operation, the first view comprehensive light intensity distribution data and the second view comprehensive light intensity data may be processed by step S136 of the method of the embodiment illustrated in FIG. 2B to calculate the set of total comprehensive distribution data. By doing so, when having a need to make the 3D image near the displaying position P2 (i.e., near the center of the display surface of the stereoscopic display 100) more clear, the user may increase the weight of the displaying position P2 to, for example, calculate the optimal viewing position according to the results of

$$\sqrt[4]{{L}_{11} \times {L}_{12} \times {L}_{12} \times {L}_{13}} and \sqrt[4]{{L}_{21} \times {L}_{22} \times {L}_{22} \times {L}_{23}} .$$

As such, when viewing at the optimal viewing position, the 3D image from the center of the display surface of the stereoscopic display 100 will be clearer. However, when having a need to make the 3D image near the displaying position P1 (i.e., the left side of the display surface of the stereoscopic display 100) more clear, the user may increase the weight of the displaying position P1 to, for example, calculate the optimal viewing position according to the results of

$$\sqrt[4]{{L}_{11} \times {L}_{11} \times {L}_{12} \times {L}_{13}} and \sqrt[4]{{L}_{21} \times {L}_{21} \times {L}_{22} \times {L}_{23}} .$$

As such, when viewing at the optimal viewing position, the 3D image from the left side of the display surface of the stereoscopic display 100 will be clearer, and likewise, the calculation of the optimal viewing position when desiring the 3D image near the displaying position P1 to be clearer may be so inferred.

Referring to FIG. 1B, FIG. 2A and FIG. 6 again, in another embodiment, step S134a of FIG. 6 may include raising at least one of the at least three sets of multiple view light intensity distribution data to the power greater than 1 to obtain at least one set of weighted multiple view light intensity distribution data, multiplying the at least one set of weighted multiple view light intensity distribution data with the rest of the multiple view light intensity distribution data to obtain a set of product data, and calculating the Mth root of the product data to obtain the set of total comprehensive distribution data, wherein M is a sum of the total power of the rest of the multiple view light intensity distribution data and the total power of the at least one set of weighted multiple view light intensity distribution data.

In the present embodiment, step S134a of FIG. 6 may include raising one of the at least three sets of multiple view light intensity distribution data the power of N to obtain a set of multiple view light intensity distribution data, wherein N is greater than or equal to 2; multiplying the weighted multiple view light intensity distribution data with the rest of the multiple view light intensity distribution data to obtain a set of product data; and calculating the Mth root of the product data to obtain the set of total comprehensive distribution data, wherein M is a sum of the number of the sets of the multiple view light intensity distribution data plus N. For instance, in order to make the 3D image near the displaying position P2 of the stereoscopic display 100 clearer, a result of

$$\sqrt[4]{\sqrt{{L}_{11} \times {L}_{21}} \times \sqrt{{L}_{12} \times {L}_{22}} \times \sqrt{{L}_{12} \times {L}_{22}} \times \sqrt{{L}_{13} \times {L}_{23}}}$$

may be calculated, and results corresponding to all the midpoint position construct the set of total comprehensive distribution data. To be more specific, a value of the multiple view light intensity distribution data that corresponds to the displaying position P2 is \sqrt{L₁₂×L₂₂}. In the present embodiment N may be set to be 2, and a value of the weighted multiple view light intensity distribution data is \sqrt{L₁₂×L₂₂})²=L₁₂×L₂₂. Values of the rest of the multiple view light intensity distribution data are \sqrt{L₁₁×L₂₁} and \sqrt{L₁₃×L₂₃}, and the product data is \sqrt{L₁₁×L₂₁}×L₁₂×L₂₂×\sqrt{L₁₃×L₂₃}. The number of the reset of the sets of the multiple view light intensity distribution data is 2 and N=2, and as a result, M=4. Therefore, the 4^{th} root of that value of the product data is calculated, i.e., calculating the result of

$$\sqrt[4]{\sqrt{{L}_{11} \times {L}_{21}} \times \sqrt{{L}_{12} \times {L}_{22}} \times \sqrt{{L}_{12} \times {L}_{22}} \times \sqrt{{L}_{13} \times {L}_{23}}} ,$$

values of

$$\sqrt[4]{\sqrt{{L}_{11} \times {L}_{21}} \times \sqrt{{L}_{12} \times {L}_{22}} \times \sqrt{{L}_{12} \times {L}_{22}} \times \sqrt{{L}_{13} \times {L}_{23}}}$$

corresponding to all the midpoint positions construct the set of total comprehensive distribution data. When the position between the user's eyebrows is located in the optimal viewing position obtained from the set of total comprehensive distribution data that is calculated in the aforementioned manner, the 3D image near the center of the stereoscopic display 100 will be clearer.

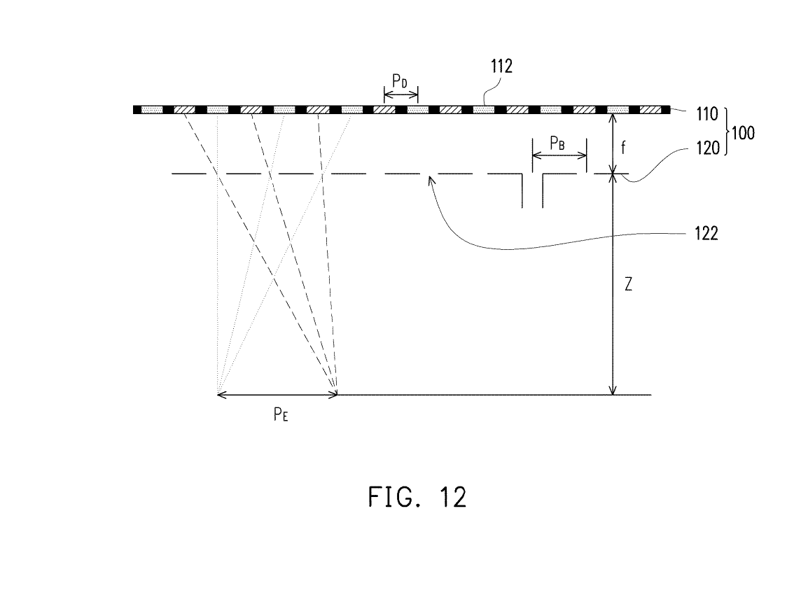

FIG. 12 is a top view illustrating detailed structures of the stereoscopic display depicted in FIG. 1A. With reference to FIG. 12, when being manufactured, the stereoscopic display 100 has ideal design parameters. In the present embodiment, the stereoscopic display 100 includes a display 110 and a parallax barrier 120. The display 110 has a plurality of pixels 112, and the parallax barrier 120 has a plurality of striped openings 122. In FIG. 12, a distance from the parallax barrier 120 to the pixels 112 of the display 110 is f, a viewing distance from a viewer's eyes to the parallax barrier 120 is Z, a period of each pixel of the display 110 is P_{D}, a period of each striped opening 122 of the parallax barrier 120 is P_{B}, and a pitch between two viewing zones is P_{E}., such as a pitch between the first viewing zone V1 and its adjacent second viewing zone V2, as shown in FIG. 1B.

$$\frac{{P}_{B}}{2 {P}_{D}} = \frac{Z}{Z + f}$$

may be inferred according to the principle of similar triangles. In this formula, P_{D}, P_{B} and f are design parameters of the stereoscopic display 100 itself. Thus, under an ideal condition, P_{D}, P_{B} and f are all given when designing the stereoscopic display 100. Accordingly, in the formula, only one parameter Z is unknown, and

$$Z = \frac{{P}_{B} f}{2 {P}_{D} - {P}_{B}}$$

may be obtained from the aforementioned formula. That is to say, when the ideal design parameters P_{D}, P_{B} and f are given, an optimal viewing distance under the ideal condition may be obtained, which is the value of Z calculated based on the formula. However, manufacturing errors of the stereoscopic display 100 are uneasy to be avoided, and thus, the value of Z calculated based on the formula can not always fit to actual conditions.

Additionally,

$$\frac{{P}_{E}}{{P}_{D}} = \frac{Z}{f}$$

may also be inferred according to the principle of similar triangles, and

$${P}_{E} = \frac{{P}_{B} {P}_{D}}{2 {P}_{D} - {P}_{B}}$$

may be obtained by substituting the calculated value of Z therein and reorganizing the formula.

Referring to FIG. 2A again, in another embodiment, before step S110 of FIG. 2A, a step of determining an optimal viewing distance in advance according to the design parameters of the stereoscopic display 100 may be included. For instance, after obtaining the value of Z (i.e., the optimal viewing distance) by applying the aforementioned method, an optimal viewing distance range may be determined according to the value of Z. For example, a range from a distance of Z−d to a distance of Z+d departing from and in front of the stereoscopic display 100 may be served as the optimal viewing distance range, and d<Z. Then, in follow-up steps S110 and S120, the first value positions Q1 and the second value positions Q2 fall within the optimal viewing distance range. Thereby, the optimal viewing distance may still be calculated when the number of measuring positions and the measuring time period are reduced. Alternatively, in another embodiment, the first value positions Q1 and the second value positions Q2 may also partially fall out of the optimal viewing distance range, and in step S130, the data measured in the part of first value positions Q1 and the part of the second value positions Q2 that fall out of the optimal viewing distance range will not be considered.

Referring to FIG. 2A, FIG. 2B and FIG. 12 again, in another embodiment, the first view light intensity and the second view light intensity of FIG. 2A may also be illuminance, and the method of measuring light intensity of the lights emitted by the at least three displaying positions P1, P2 and P3 corresponding to the first viewing zone V1 and the second viewing zone V2 is to measure light intensity (i.e., illuminance) of the lights emitted by the at least three displaying positions P1, P2 and P3 corresponding to the first viewing zone V1 and the second viewing zone V2 at positions Q where the values are located. In other words, the positions Q where the values are located are measuring positions where the light intensity meter 220 (e.g., an illuminance meter) are located.

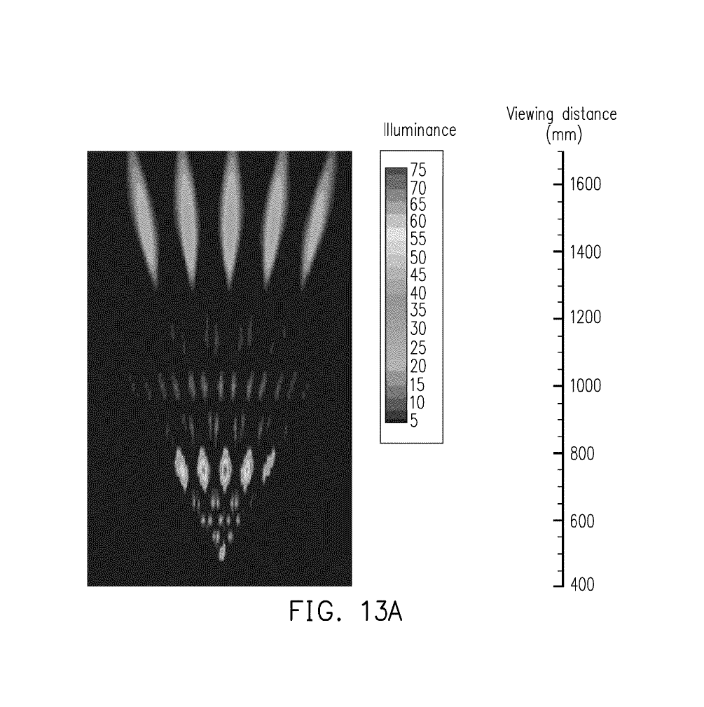

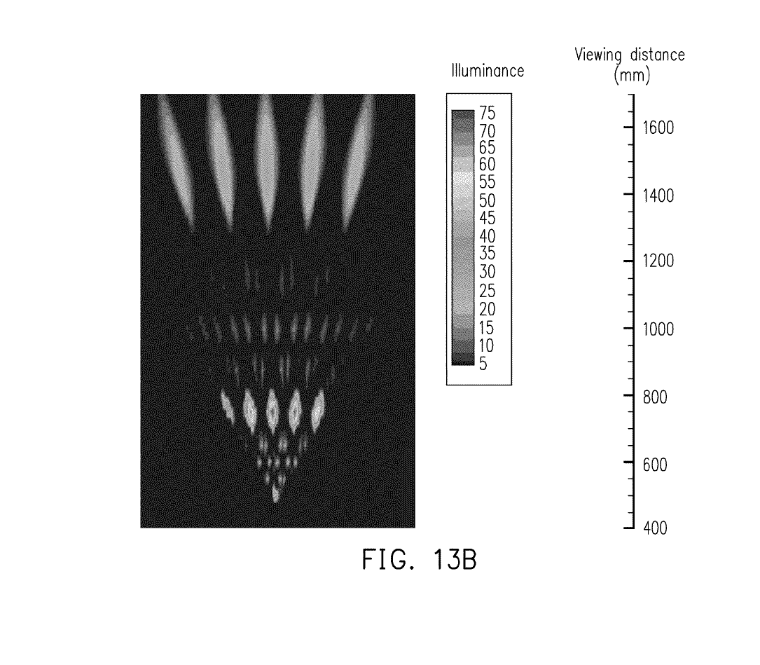

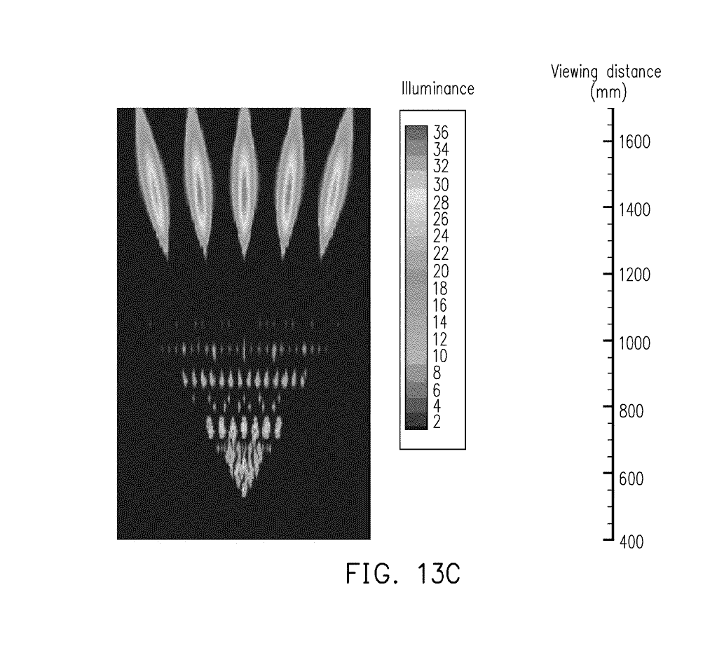

Accordingly, in an embodiment, the first view comprehensive light intensity distribution data of FIG. 2B is what is illustrated in FIG. 13A, the second view comprehensive light intensity value of FIG. 2B is what is illustrated in FIG. 13B, and the set of total comprehensive distribution data of FIG. 2A and FIG. 2B is what is illustrated in FIG. 13C. In FIG. 13A, FIG. 13B and FIG. 13C, viewing distances refer to a perpendicular distance from the first value position Q1 (as shown in FIG. 13A), a perpendicular distance from the second value position Q2 (as shown in FIG. 13B) and a perpendicular distance from the midpoint position to the stereoscopic display 100, and a position in a direction perpendicular to a viewing distance refers to the y-axial position of FIG. 1B. In accordance with FIG. 13A through FIG. 13C, the illuminance is reduced with the increase of the viewing distance, and thus, in the present embodiment, after determining the optimal viewing distance range by calculating the value of Z as described above, a maximum value among the set of total comprehensive distribution data in the optimal viewing distance range may be selected as the optimal viewing position, and an accurate optimal viewing position may still be obtained in this way. Alternatively, in another embodiment, a viewing position corresponding to a relative maximum value among the set of total comprehensive distribution data in the optimal viewing distance range may be selected as the optimal viewing position. Therein, the relative maximum value corresponds to a viewing position with a distance to the stereoscopic display 100 that is the nearest to the value of Z.

In FIG. 12, an example where the parallax barrier 120 is disposed between the viewer and the display 110 is illustrated. However, in other embodiments, when the display 110 is a liquid crystal display (LCD), the parallax barrier 120 may also be disposed between a backlight module and an LCD panel of the LCD. As such, an optimal viewing distance (i.e., a perpendicular distance from the viewer's eyes to the LCD panel) under an ideal condition may be calculated according to design parameters of the parallax barrier and the LCD.

Moreover, the method of calculating the optimal viewing distance range (e.g., by calculating the value of Z) under the ideal condition in advance and then calculating the optimal viewing position based on the optimal viewing distance range may also be applied to the embodiment where the first view light intensity and the second view light intensity are luminance to reduce calculation amount and the number of measuring positions.

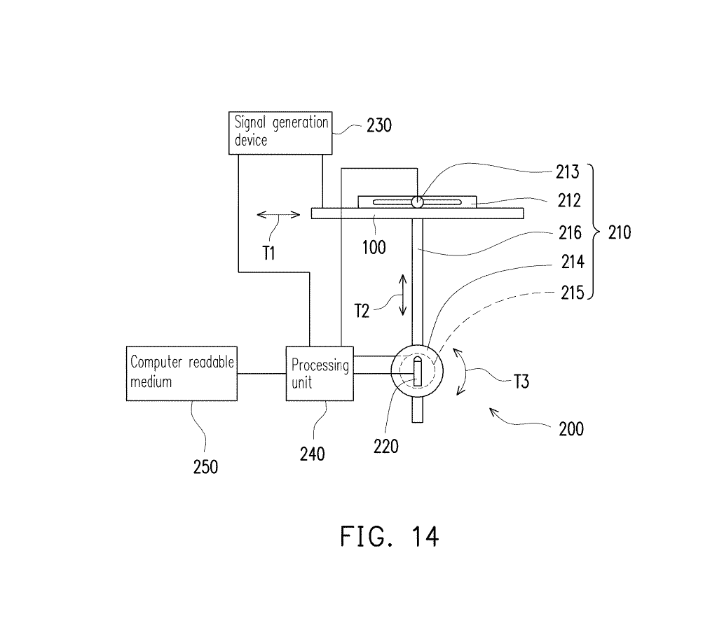

FIG. 14 is a schematic view illustrating a measurement apparatus according to an embodiment of the disclosure. With reference to FIG. 14, in the present embodiment, a measurement apparatus 200 for measuring a stereoscopic display is adapted to the stereoscopic display 100. The measurement apparatus 200 includes a movable support unit 210, a light intensity meter 220, a signal generation device 230 and a processing unit 240. The movable support unit 210 includes a first carrying portion 212 and a second carrying portion 214. The second carrying portion 214 is suitable for moving relatively to the first carrying portion 212 to different positions and directions. The first carrying portion 212 is served to carry the stereoscopic display 100, and the light intensity meter 220 is disposed on the second carrying portion 214. When the second carrying portion 214 moves relatively to the first carrying portion 212 to different positions and directions, the light intensity meter 220 are located at different measuring positions (e.g., the first value positions Q1 and the second value positions Q2 depicted in FIG. 1B when, for example, measuring the illuminance) or at different viewing angles (e.g., when measuring the illuminance) to measure light intensity of lights emitted by the stereoscopic display 100 corresponding to the different displaying positions P1, P2 and P3. In the present embodiment, the movable support unit 210 further includes a connection portion 216 connecting the first carrying portion 212 with the second carrying portion 214. In the present embodiment, the first carrying portion 212 may be slidably connected to the connection portion 216, and the second carrying portion 214 may be rotatably and slidably connected to the connection portion 216. For instance, the first carrying portion 212 may slide along a first direction T1 to drive the stereoscopic display 100 to move horizontally along the first direction T1. Additionally, the second carrying portion 214 may slide along second direction T2. In the present embodiment, the connection portion 216 may be served as a rail, such that the second carrying portion 214 slides on the rail to drive the light intensity meter 220 to translate along the second direction T2. Moreover, the second carrying portion 214 may rotate relatively to the connection portion 216 around a third direction T3 (such as around an axis substantially perpendicular to the first direction T1 and the second direction T2) to drive the light intensity meter 220 to rotate. By the aforementioned operation of the movable support unit 210, the light intensity meter 220 may be located at each of the first value positions Q1 and each of the second value positions Q2 depicted in FIG. 1C or at each of the viewing angles depicted in FIG. 1B to measure the light intensity of the lights from the different displaying positions P1, P2 and P3 of the stereoscopic display 100.

In the present embodiment, the measurement apparatus 200 may further include a first actuator 213 and a second actuator 215. The first actuator 213 is connected with the first carrying portion 212 and the connection portion 216 to drive the first carrying portion 212 to move along the first direction T1. The second actuator 215 is connected with the second carrying portion 214 and the connection portion 216 to drive the second carrying portion 214 to move along the second direction T2 and to drive the second carrying portion 214 to rotate around the third direction T3.

The signal generation device 230 is electrically connected to the stereoscopic display 100 to output a test pattern signal to the stereoscopic display 100. For instance, the signal generation device 230 may generate a first view test pattern signal to the stereoscopic display 100, such that the at least three displaying positions P1, P2 and P3 of the stereoscopic display 100 emit lights corresponding to the first viewing zone V1 (i.e., the condition as illustrated in FIG. 3A). Additionally, the signal generation device 230 may generate a second view test pattern signal to the stereoscopic display 100, such that the at least three displaying positions P1, P2 and P3 of the stereoscopic display 100 emit lights corresponding to the second viewing zone V2.

The processing unit 240 is electrically connected to the light intensity meter 220 to calculate actual parameters, such as the optimal viewing position or the optimal viewing distance of the stereoscopic display 100 according to the light intensity measured by the light intensity meter 220. In the present embodiment, the processing unit 240 is also electrically connected with the movable support unit 210, such as with the first actuator 213 and the second actuator 215, such that the processing unit 240 may control the operation of the movable support unit 210 by instructing the first actuator 213 and the second actuator 215 to operate. Moreover, in the present embodiment, the processing unit 240 may be electrically connected to the signal generation device 230 to instruct the signal generation device 230 to generate the test pattern signal (e.g., the first view test pattern signal and the second view test pattern signal).

With reference to FIG. 2A and FIG. 14, in the present embodiment, the measurement apparatus 200 may further include a computer readable medium 250 which stores a computer program product served to measure the stereoscopic display. Instructions of the computer program product may be loaded into the processing unit 240 for the processing unit 240 to perform the measurement method of each of the embodiments introduced by the disclosure. For instance, the computer program product may include first instructions, second instructions, third instructions and fourth instructions (as illustrated in FIG. 2A). When loading the first instructions, the processing unit 240 may correspondingly perform step S110; when loading the second instructions, the processing unit 240 may correspondingly perform step S120; when loading the third instructions, the processing unit 240 may correspondingly perform step S130; and when loading the fourth instructions, the processing unit 240 may correspondingly perform step S140. Moreover, the steps and other steps of the measurement method introduced in this embodiment or other embodiments of the disclosure may be performed by loading corresponding instructions from the computer program product into the processing unit 240 so as to execute the steps and other steps in this embodiment or other embodiments. In the present embodiment, the processing unit 240 may execute the instructions of the computer program product to control the detection timing of the light intensity meter 220 and may calculate the light intensity values detected by the light intensity meter 220. Besides, the processing unit 240 may execute the instructions of the computer program product to control the operation of the movable support unit 210 (e.g., to control the operations of the first actuator 213 and the second actuator 215) so as to change detection positions and directions of the light intensity meter 220. Further, the processing unit 240 may execute the instructions of the computer program product to control the signal generation device 230 to generate the test pattern signal. Additionally, the processing unit 240 lay load the instructions of the computer program product to perform the operations in the measurement method of each of the embodiments introduced by the disclosure. In the present embodiment, the processing unit 240 is a processor.

However, in other embodiments, the processing unit 240 may also be implemented in a hardware form. For instance, the measurement apparatus 200 may not include the computer readable medium, and the processing unit 240 may be a logic circuit, such as a digital logic circuit. The digital logic circuit may implement the measurement method of each of the embodiments introduced by the disclosure by controlling the light intensity meter 220, the movable support unit 210 and the signal generation device 230 and utilizing the computing capabilities of itself.

To sum up, in the measurement method, the measurement apparatus and the computer program product on the embodiments introduced by the disclosure, the set of total comprehensive distribution data is calculated according to the sets of the first view light intensity distribution data and the sets of the second view light intensity distribution data, then the optimal viewing position in the space in front of the stereoscopic display is determined according to the set of total comprehensive distribution data, and thereby, not only the optimal viewing distance but also the optimal viewing position can be calculated by the measurement method, the measurement apparatus and the computer program product on the embodiments introduced by the disclosure. Accordingly, even though manufacturing errors exit in the design parameters of the stereoscopic display, the optimal viewing position can also be estimated more accurately. Moreover, the estimated optimal viewing position can be utilized to determine whether there is any issue regarding the design parameters of the stereoscopic display and also whether the manufacturing errors of the stereoscopic display are overly large and beyond the tolerable rang to transmit a feedback message to a manufacturer of the stereoscopic display to facilitate in future process improvement.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A measurement method configured to measure a stereoscopic display, comprising:
causing at least three different displaying positions of the stereoscopic display to emit lights corresponding to a first viewing zone and measuring a plurality of light intensities of the lights emitted by the at least three displaying positions corresponding to the first viewing zone to respectively obtain at least three sets of first view light intensity distribution data, wherein the at least three displaying positions have different abscissa values;
causing the at least three different displaying positions of the stereoscopic display to emit lights corresponding to a second viewing zone and measuring a plurality of light intensities of the lights emitted by the at least three displaying positions corresponding to the second viewing zone to respectively obtain at least three sets of second view light intensity distribution data, wherein the at least three sets of first view light intensity distribution data and the at least three sets of second view light intensity distribution data are distribution data of a plurality of light intensity values respectively corresponding to positions where a plurality of values are located in space in front of the stereoscopic display;
calculating a set of total comprehensive distribution data according to the at least three sets of first view light intensity distribution data and the at least three sets of second view light intensity distribution data; and
determining an optimal viewing position in the space in front of the stereoscopic display according to the set of total comprehensive distribution data.

2. The method according to claim 1, wherein the step of measuring the light intensities of the lights emitted by the at least three displaying positions respectively corresponding to the first viewing zone and the second viewing zone comprises:
measuring the light intensities of the lights emitted by the at least three displaying positions respectively corresponding to the first viewing zone and the second viewing zone at a plurality of viewing angles, wherein the positions where the plurality of values are located are obtained by converting the plurality of viewing angles.

3. The method according to claim 2, wherein the light intensity is luminance.

4. The method according to claim 1, wherein the step of measuring the light intensities of the lights emitted by the at least three displaying positions respectively corresponding to the first viewing zone and the second viewing zone comprises:
measuring the light intensities of the lights emitted by the at least three displaying positions respectively corresponding to the first viewing zone and the second viewing zone in the positions where the plurality of values are located.

5. The method according to claim 4, wherein the light intensity is illuminance.

6. The method according to claim 1, wherein the step of calculating the set of total comprehensive distribution data according to the at least three sets of first view light intensity distribution data and the at least three sets of second view light intensity distribution data comprises:
performing a corresponding multiplication operation on the at least three sets of first view light intensity distribution data and the at least three sets of second view light intensity distribution data to calculate the set of total comprehensive distribution data.

7. The method according to claim 6, wherein the step of performing the corresponding multiplication on the at least three sets of first view light intensity distribution data and the at least three sets of first view light intensity distribution data comprises:
defining the positions where the plurality of values of the at least three sets of first view light intensity distribution data and the at least three sets of second view light intensity distribution data are located as a plurality of position pairs, wherein each of the position pairs comprises a first value position and a second value position, distances between the first value positions and the corresponding second value positions in the plurality of position pairs are substantially the same, and a first value position in one of the position pairs and a second value position in another one of the position pairs are a same position, or the first value positions do not coincide with the second value positions in the position pairs;
multiplying the light intensity values of the at least three sets of first view light intensity distribution data corresponding to the first value position with the light intensity values of the at least three sets of second view light intensity distribution data corresponding to the second value position in a same position pair and mapping the multiplication result to a midpoint position of the first value position and the second value position of the position pair; and
serving the multiplication results and the midpoint positions corresponding to the multiplication results in the position pairs as the set of total comprehensive distribution data.

8. The method according to claim 6, wherein the step of calculating the set of total comprehensive distribution data according to the at least three sets of first view light intensity distribution data and the at least three sets of second view light intensity distribution data comprises:
performing an operation of correspondingly evaluating geometric means of the at least three sets of first view light intensity distribution data and the at least three sets of second view light intensity distribution data to obtain the set of total comprehensive distribution data.

9. The method according to claim 1, wherein the step of calculating the set of total comprehensive distribution data according to the at least three sets of first view light intensity distribution data and the at least three sets of second view light intensity distribution data comprises:
raising at least one of the at least three sets of first view light intensity distribution data to a power greater than 1 to obtain at least one set of weighted first view light intensity distribution data;
raising at least one of the at least three sets of second view light intensity distribution data to a power greater than 1 to obtain at least one set of weighted second view light intensity distribution data, wherein the displaying positions corresponding to the weighted second view light intensity distribution data and the displaying positions corresponding to the weighted first view light intensity distribution data are substantially the same; and
multiplying the at least one set of weighted first view light intensity distribution data, the rest of the first view light intensity distribution data, the at least one set of weighted second view light intensity distribution data and the rest of the second view light intensity distribution data so as to calculate the set of total comprehensive distribution data.

10. The method according to claim 9, further comprising:
after multiplying the at least one set of weighted first view light intensity distribution data, the rest of the first view light intensity distribution data, the at least one set of weighted second view light intensity distribution data and the rest of the second view light intensity distribution data, calculating a Kth root of the multiplication result to obtain the set of total comprehensive distribution data, wherein K is a sum of the total power of the rest of the first view light intensity distribution data, the total power of the at least one set of weighted first view light intensity distribution data, the total power of the rest of the second view light intensity distribution data and the total power of the at least one set of weighted second view light intensity distribution data.

11. The method according to claim 1, wherein the step of calculating the set of total comprehensive distribution data according to the at least three sets of first view light intensity distribution data and the at least three sets of second view light intensity distribution data comprises:
selecting light intensity values from the at least three sets of first view light intensity distribution data whose uniformity conforms to a predetermined condition and corresponding positions where the selected light intensity values are located as at least three sets of adjusted first view light intensity distribution data;
selecting light intensity values from the at least three sets of second view light intensity distribution data whose uniformity conforms to a predetermined condition and corresponding positions where the selected light intensity values are located as at least three sets of adjusted second view light intensity distribution data; and
calculating the set of total comprehensive distribution data according to the at least three sets of adjusted first view light intensity distribution data and the at least three sets of adjusted second view light intensity distribution data.

12. The method according to claim 11, wherein the predetermined condition is set to be greater than a threshold or to be greater than or equal to the threshold.

13. The method according to claim 1, wherein the step of calculating the set of total comprehensive distribution data according to the at least three sets of first view light intensity distribution data and the at least three sets of second view light intensity distribution data comprises:
evaluating a plurality of first system crosstalk (SCT) values for the positions where the values in each of the sets of first view light intensity distribution data are located and selecting first SCT values that conform to a predetermined condition from the plurality of first SCT values as a plurality of selected first SCT values;
evaluating a plurality of second SCT values for the positions where the values in each of the sets of second view light intensity distribution data are located and selecting second SCT values that conform to the predetermined condition from the plurality of second SCT values as a plurality of selected second SCT values; and
calculating the set of total comprehensive distribution data according to the at least three sets of first view light intensity distribution data, the at least three sets of second view light intensity distribution data, the plurality of selected first SCT values and the plurality of selected second SCT values.

14. The method according to claim 13, wherein the predetermined condition is set to be less than a threshold or to be less than or equal to the threshold.

15. The method according to claim 13, wherein calculating the set of total comprehensive distribution data according to the at least three sets of first view light intensity distribution data, the at least three sets of second view light intensity distribution data, the plurality of selected first SCT values and the plurality of selected second SCT values comprises:
serving a product of respectively multiplying the light intensity values corresponding to positions where the values having the first SCT values conforming to the predetermined condition are located in each set of first view light intensity distribution data with reciprocals of the selected first SCT values as a set of first view light intensity crosstalk distribution data;
serving a product of respectively multiplying the light intensity values corresponding to positions where the values having the second SCT values conforming to the predetermined condition are located in each set of second view light intensity distribution data with reciprocals of the selected second SCT values as a set of second view light intensity crosstalk distribution data; and
calculating the set of total comprehensive distribution data according to the at least three sets of first view light intensity crosstalk distribution data and the at least three sets of second view light intensity crosstalk distribution data.

16. The method according to claim 1, wherein the at least three different displaying positions are located on a same horizontal line of the stereoscopic display, and the horizontal line is substantially parallel to an arrangement direction of the first viewing zone and the second viewing zone.

17. The method according to claim 1, wherein at least two of the at least three different displaying positions are located on different horizontal lines of the stereoscopic display, the horizontal lines are substantially parallel to an arrangement direction of the first viewing zone and the second viewing zone, the at least three different displaying positions are respectively located on different vertical lines of the stereoscopic display, and the vertical lines are substantially perpendicular to the arrangement direction of the first viewing zone and the second viewing zone.

18. The method according to claim 1, wherein the step of determining the optimal viewing position in the space in front of the stereoscopic display according to the set of total comprehensive distribution data comprises:
determining the optimal viewing position according to a position corresponding to an extreme value in the set of total comprehensive distribution data.

19. The method according to claim 18, wherein the step of determining the optimal viewing position according to the position corresponding to the extreme value in the set of total comprehensive distribution data comprises:
selecting a midpoint position of the position where the values corresponding to the light intensity values in the at least three sets of first view light intensity distribution data and corresponding to the extreme value in the set of total comprehensive distribution data are located and the position where the values corresponding to the light intensity values in the at least three sets of second view light intensity distribution data and corresponding to the extreme value in the set of total comprehensive distribution data are located as the optimal viewing position, wherein the optimal viewing position corresponds to a midpoint position between a user's eyes.

20. The method according to claim 18, wherein the extreme value is an absolute maximum value.

21. The method according to claim 18, further comprising:
serving a perpendicular distance between the optimal viewing position and the stereoscopic display as an optimal viewing distance.

22. The method according to claim 1, further comprising:
determining an optimal viewing distance range according to design parameters of the stereoscopic display, wherein the positions where the values are located fall within the optimal viewing distance range.

23. A measurement apparatus for a stereoscopic display, comprising:
a movable support unit, comprising a first carrying portion and a second carrying portion, wherein the second carrying portion is configured to move relatively to the first carrying portion to different positions and directions, and the first carrying portion is configured to carry the stereoscopic display;
a light intensity meter, disposed on the second carrying portion, wherein when the second carrying portion moves relatively to the first carrying portion to different positions and directions, the light intensity meter measures a plurality of light intensities of lights emitted from different displaying positions of the stereoscopic display in different measuring positions or different viewing angles;
a signal generation device, configured to electrically connect with the stereoscopic display to output a test pattern signal to the stereoscopic display; and
a processing unit, electrically connected to the light intensity meter to calculate actual parameters of the stereoscopic display according to the plurality of light intensities measured by the light intensity meter.

24. The measurement apparatus according to claim 23, wherein the processing unit is further electrically connected with the movable support unit and the signal generation device, the processing unit is configured to instruct the signal generation device to generate a first view test pattern signal to the stereoscopic display so as to cause at least three different displaying positions of the stereoscopic display to emit lights corresponding to the first viewing zone while the movable support unit is operated to cause the light intensity meter to measure the light intensity of the lights emitted by the at least three displaying positions corresponding to the first viewing zone so as to respectively obtain at least three sets of first view light intensity distribution data, wherein the at least three different displaying positions have different abscissa values;
the processing unit is configured to instruct the signal generation device to generate a second view test pattern signal to the stereoscopic display so as to cause the at least three different displaying positions of the stereoscopic display to emit lights corresponding to the second viewing zone while the movable support unit is operated to cause the light intensity meter to measure the light intensity of the lights emitted by the at least three displaying positions corresponding to the second viewing zone so as to respectively obtain at least three sets of second view light intensity distribution data, wherein the at least three sets of first view light intensity distribution data and the at least three sets of second view light intensity distribution data are distribution data of a plurality of light intensity values respectively corresponding to positions where a plurality of values are located in space in front of the stereoscopic display;
the processing unit calculates a set of total comprehensive distribution data according to the at least three sets of first view light intensity distribution data and the at least three sets of second view light intensity distribution data; and
the processing unit determines an optimal viewing position in the space in front of the stereoscopic display according to the set of total comprehensive distribution data.

25. The measurement apparatus according to claim 24, wherein the light intensity meter measures the light intensity of the lights emitted by the at least three displaying positions corresponding to the first viewing zone and the second viewing zone at different viewing angles, and the positions where the plurality of values are located are obtained by converting the plurality of viewing angles.

26. The measurement apparatus according to claim 25, wherein the light intensity is luminance.

27. The measurement apparatus according to claim 24, wherein the light intensity meter measures the light intensity of the lights emitted by the at least three displaying positions corresponding to the first viewing zone and the second viewing zone in the positions where the values are located.

28. The measurement apparatus according to claim 27, wherein the light intensity is illuminance.

29. The measurement apparatus according to claim 24, wherein the processing unit performs a corresponding multiplication operation on the at least three sets of first view light intensity distribution data and the at least three sets of second view light intensity distribution data so as to calculate the set of total comprehensive distribution data.

30. The measurement apparatus according to claim 29, wherein the processing unit defines the positions where the values of the at least three sets of first view light intensity distribution data and the at least three sets of second view light intensity distribution data are located as a plurality of position pairs, each of the position pairs comprises a first value position and a second value position, distances between the first value positions and the corresponding second value positions in the plurality of position pairs are substantially the same, a first value position in one of the position pairs and a second value position in another one of the position pairs is a same position, or the first value positions do not coincide with the second value positions in the position pairs;
the processing unit multiplies the light intensity values in the at least three sets of first view light intensity distribution data light intensity values corresponding to the first value position with the light intensity values in the at least three sets of second view light intensity distribution data corresponding the second value position in a same position pair and maps the multiplication result to a midpoint position of the first value position and the second value position in the position pair; and
the processing unit serves the multiplication results and the midpoint positions corresponding to the multiplication results in the position pairs as the set of total comprehensive distribution data.

31. The measurement apparatus according to claim 29, wherein the processing unit performs an operation of correspondingly evaluating geometric means of the at least three sets of first view light intensity distribution data and the at least three sets of second view light intensity distribution data to obtain the set of total comprehensive distribution data.

32. The measurement apparatus according to claim 24, wherein the processing unit raises at least one of the at least three sets of first view light intensity distribution data to a power greater than 1 to obtain at least one set of weighted first view light intensity distribution data;
the processing unit raises at least one of the at least three sets of second view light intensity distribution data to a power greater than 1 to obtain at least one set of weighted second view light intensity distribution data, wherein the displaying positions corresponding to the weighted second view light intensity distribution data and the displaying positions corresponding to the weighted first view light intensity distribution data are substantially the same; and
the processing unit multiplies the at least one set of weighted first view light intensity distribution data, the rest of the first view light intensity distribution data, the at least one set of weighted second view light intensity distribution data and the rest of the second view light intensity distribution data so as to calculate the set of total comprehensive distribution data.

33. The measurement apparatus according to claim 32, wherein after multiplying the at least one set of weighted first view light intensity distribution data, the rest of the first view light intensity distribution data, the at least one set of weighted second view light intensity distribution data and the rest of the second view light intensity distribution data, the processing unit calculates a Kth root of a result of the multiplication result to obtain the set of total comprehensive distribution data, wherein K is a sum of the total power of the rest of the first view light intensity distribution data, the total power of the at least one set of weighted first view light intensity distribution data, the total power of the rest of the second view light intensity distribution data and the total power of the at least one set of weighted second view light intensity distribution data.

34. The measurement apparatus according to claim 24, wherein
the processing unit selects light intensity values from the at least three sets of first view light intensity distribution data whose uniformity conforms to a predetermined condition and corresponding positions where the selected light intensity values are located as at least three sets of adjusted first view light intensity distribution data;
the processing unit selects light intensity values from the at least three sets of second view light intensity distribution data whose uniformity conforms to a predetermined condition and corresponding positions where the selected light intensity values are located as at least three sets of adjusted second view light intensity distribution data; and
the processing unit calculates the set of total comprehensive distribution data according to the at least three sets of adjusted first view light intensity distribution data and the at least three sets of adjusted second view light intensity distribution data.

35. The measurement apparatus according to claim 34, wherein the predetermined condition is set to be greater than a threshold or to be greater than or equal to the threshold.

36. The measurement apparatus according to claim 24, wherein the processing unit evaluates a plurality of first system crosstalk (SCT) values for the positions where the values in each of the sets of first view light intensity distribution data are located and selects first SCT values that conform to a predetermined condition from the plurality of first SCT values as a plurality of selected first SCT values;
the processing unit evaluates a plurality of second SCT values for the positions where the values in each of the sets of second view light intensity distribution data are located and selects second SCT values that conform to the predetermined condition from the plurality of second SCT values as a plurality of selected second SCT values; and
the processing unit calculates the set of total comprehensive distribution data according to the at least three sets of first view light intensity distribution data, the at least three sets of second view light intensity distribution data, the plurality of selected first SCT values and the plurality of selected second SCT values.

37. The measurement apparatus according to claim 36, wherein the predetermined condition is set to be less than a threshold or to be less than or equal to the threshold.

38. The measurement apparatus according to claim 36, wherein the processing unit serves a product of respectively multiplying the light intensity values corresponding to positions where the values having the first SCT values conforming to the predetermined condition are located in each set of first view light intensity distribution data with reciprocals of the selected first SCT values as a set of first view light intensity crosstalk distribution data;
the processing unit serves a product of respectively multiplying the light intensity values corresponding to positions where the values having the second SCT values conforming to the predetermined condition are located in each set of second view light intensity distribution data with reciprocals of the selected second SCT values as a set of second view light intensity crosstalk distribution data; and
the processing unit calculates the set of total comprehensive distribution data according to the at least three sets of first view light intensity crosstalk distribution data and the at least three sets of second view light intensity crosstalk distribution data.

39. The measurement apparatus according to claim 24, wherein the at least three different displaying positions are located on a same horizontal line of the stereoscopic display, and the horizontal line is substantially parallel to an arrangement direction of the first viewing zone and the second viewing zone.

40. The measurement apparatus according to claim 24, wherein at least two of the at least three different displaying positions are located on different horizontal lines of the stereoscopic display, the horizontal lines are substantially parallel to an arrangement direction of the first viewing zone and the second viewing zone, the at least three different displaying positions are respectively located on different vertical lines of the stereoscopic display, and the vertical lines are substantially perpendicular to the arrangement direction of the first viewing zone and the second viewing zone.

41. The measurement apparatus according to claim 24, wherein the processing unit determines the optimal viewing position according to a position corresponding to an extreme value in the set of total comprehensive distribution data.

42. The measurement apparatus according to claim 41, wherein the processing unit selects a midpoint position of the position where the values corresponding to the light intensity values in the at least three sets of first view light intensity distribution data and corresponding to the extreme value in the set of total comprehensive distribution data are located and the position where the values corresponding to the light intensity values in the at least three sets of second view light intensity distribution data and corresponding to the extreme value in the set of total comprehensive distribution data are located as the optimal viewing position, wherein the optimal viewing position corresponds to a midpoint position between a user's eyes.

43. The measurement apparatus according to claim 41, wherein the extreme value is an absolute maximum value.

44. The measurement apparatus according to claim 41, wherein the processing unit serves a perpendicular distance between the optimal viewing position and the stereoscopic display as an optimal viewing distance.

45. The measurement apparatus according to claim 24, wherein the processing unit determines an optimal viewing distance range according to design parameters of the stereoscopic display, wherein the positions where the values are located fall within the optimal viewing distance range.

46. A computer program product in a computer readable medium for measuring a stereoscopic display, comprising:
first instructions, configured to cause at least three different displaying positions of the stereoscopic display to emit lights corresponding to a first viewing zone and to measure a plurality of light intensities of the lights emitted by the at least three displaying positions corresponding to the first viewing zone to respectively obtain at least three sets of first view light intensity distribution data, wherein the at least three displaying positions have different abscissa values;
second instructions, configured to cause the at least three different displaying positions of the stereoscopic display to emit lights corresponding to a second viewing zone and to measure a plurality of light intensities of the lights emitted by the at least three displaying positions corresponding to the second viewing zone to respectively obtain at least three sets of second view light intensity distribution data, wherein the at least three sets of first view light intensity distribution data and the at least three sets of second view light intensity distribution data are distribution data of a plurality of light intensity values respectively corresponding to positions where a plurality of values are located in space in front of the stereoscopic display;
third instructions, configured to calculate a set of total comprehensive distribution data according to the at least three sets of first view light intensity distribution data and the at least three sets of second view light intensity distribution data; and
fourth instructions, configured to determine an optimal viewing position in the space in front of the stereoscopic display according to the set of total comprehensive distribution data.

47. The computer program product according to claim 46, wherein the instructions configured to measure the plurality of light intensities of the lights emitted by the at least three displaying positions corresponding to the first viewing zone and the second viewing zone comprise:
instructions configured to measure the light intensities of the lights emitted by the at least three displaying positions respectively corresponding to the first viewing zone and the second viewing zone at a plurality of viewing angles, wherein the positions where the plurality of values are located are obtained by converting the plurality of viewing angles.

48. The computer program product according to claim 47, wherein the light intensity is luminance.

49. The computer program product according to claim 46, wherein the instructions configured to measure the light intensities of the lights emitted by the at least three displaying positions respectively corresponding to the first viewing zone and the second viewing zone comprise:
instructions configured to measure the light intensities of the lights emitted by the at least three displaying positions respectively corresponding to the first viewing zone and the second viewing zone in the positions where the plurality of values are located.

50. The computer program product according to claim 49, wherein the light intensity is illuminance.

51. The computer program product according to claim 46, wherein the third instructions comprise:
instructions configured to perform a corresponding multiplication operation on the at least three sets of first view light intensity distribution data and the at least three sets of second view light intensity distribution data to calculate the set of total comprehensive distribution data.

52. The computer program product according to claim 51, wherein the instructions configured to perform the corresponding multiplication operation on the at least three sets of first view light intensity distribution data and the at least three sets of first view light intensity distribution data comprise:
instructions configured to define the positions where the plurality of values of the at least three sets of first view light intensity distribution data and the at least three sets of second view light intensity distribution data are located as a plurality of position pairs, wherein each of the position pairs comprises a first value position and a second value position, distances between the first value positions and the corresponding second value positions in the plurality of position pairs are substantially the same, and a first value position in one of the position pairs and a second value position in another one of the position pairs are a same position, or the first value positions do not coincide with the second value positions in the position pairs;
instructions configured to multiply the light intensity values of the at least three sets of first view light intensity distribution data corresponding to the first value position with the light intensity values of the at least three sets of second view light intensity distribution data corresponding to the second value position in a same position pair and to map the multiplication result to a midpoint position of the first value position of the second value position of the position pair; and
instructions configured to serve the multiplication results and the midpoint positions corresponding to the multiplication results in the position pairs as the set of total comprehensive distribution data.

53. The computer program product according to claim 51, wherein the instructions configured to calculate the set of total comprehensive distribution data according to the at least three sets of first view light intensity distribution data and the at least three sets of second view light intensity distribution data comprise:
instructions configured to perform an operation of correspondingly evaluating geometric means of the at least three sets of first view light intensity distribution data and the at least three sets of second view light intensity distribution data to obtain the set of total comprehensive distribution data.

54. The computer program product according to claim 46, wherein the instructions configured to calculate the set of total comprehensive distribution data according to the at least three sets of first view light intensity distribution data and the at least three sets of second view light intensity distribution data comprise:
instructions configured to raise at least one of the at least three sets of first view light intensity distribution data to a power greater than 1 to obtain at least one set of weighted first view light intensity distribution data;
instructions configured to raise at least one of the at least three sets of second view light intensity distribution data to a power greater than 1 to obtain at least one set of weighted second view light intensity distribution data, wherein the displaying positions corresponding to the weighted second view light intensity distribution data and the displaying positions corresponding to the weighted first view light intensity distribution data are substantially the same; and
instructions configured to multiply the at least one set of weighted first view light intensity distribution data, the rest of the first view light intensity distribution data, the at least one set of weighted second view light intensity distribution data and the rest of the second view light intensity distribution data so as to calculate the set of total comprehensive distribution data.

55. The computer program product according to claim 54, further comprising:
instructions configured to, after multiplying the at least one set of weighted first view light intensity distribution data, the rest of the first view light intensity distribution data, the at least one set of weighted second view light intensity distribution data and the rest of the second view light intensity distribution data, calculate a Kth root of the multiplication result to obtain the set of total comprehensive distribution data, wherein K is a sum of the total power of the rest of the first view light intensity distribution data, the total power of the at least one set of weighted first view light intensity distribution data, the total power of the rest of the second view light intensity distribution data and the total power of the at least one set of weighted second view light intensity distribution data.

56. The computer program product according to claim 46, wherein the third instructions comprise:
instructions configured to select light intensity values from the at least three sets of first view light intensity distribution data whose uniformity conforms to a predetermined condition and corresponding positions where the selected light intensity values are located as at least three sets of adjusted first view light intensity distribution data;
instructions configured to select light intensity values from the at least three sets of second view light intensity distribution data whose uniformity conforms to a predetermined condition and corresponding positions where the selected light intensity values are located as at least three sets of adjusted second view light intensity distribution data; and
instructions configured to calculate the set of total comprehensive distribution data according to the at least three sets of adjusted first view light intensity distribution data and the at least three sets of adjusted second view light intensity distribution data.

57. The computer program product according to claim 56, wherein the predetermined condition is set to be greater than a threshold or to be greater than or equal to the threshold.

58. The computer program product according to claim 46, wherein the third instructions comprise:
instructions configured to evaluate a plurality of first system crosstalk (SCT) values for the positions where the values in each of the sets of first view light intensity distribution data are located and select first SCT values that conform to a predetermined condition from the plurality of first SCT values as a plurality of selected first SCT values;
instructions configured to evaluate a plurality of second SCT values for the positions where the values in each of the sets of second view light intensity distribution data are located and select second SCT values that conform to the predetermined condition from the plurality of second SCT values as a plurality of selected second SCT values; and
instructions configured to calculate the set of total comprehensive distribution data according to the at least three sets of first view light intensity distribution data, the at least three sets of second view light intensity distribution data, the plurality of selected first SCT values and the plurality of selected second SCT values.

59. The computer program product according to claim 58, wherein the predetermined condition is set to be less than a threshold or to be less than or equal to the threshold.

60. The computer program product according to claim 58, wherein the instructions configured to calculate the set of total comprehensive distribution data according to the at least three sets of first view light intensity distribution data, the at least three sets of second view light intensity distribution data, the plurality of selected first SCT values and the plurality of selected second SCT values comprise:
instructions configured to serve a product of respectively multiplying the light intensity values corresponding to positions where the values having the first SCT values conforming to the predetermined condition are located in each set of first view light intensity distribution data with reciprocals of the selected first SCT values as a set of first view light intensity crosstalk distribution data;
instructions configured to serve a product of respectively multiplying the light intensity values corresponding to positions where the values having the second SCT values conforming to the predetermined condition are located in each set of second view light intensity distribution data with reciprocals of the selected second SCT values as a set of second view light intensity crosstalk distribution data; and
instructions configured to calculate the set of total comprehensive distribution data according to the at least three sets of first view light intensity crosstalk distribution data and the at least three sets of second view light intensity crosstalk distribution data.

61. The computer program product according to claim 46, wherein the at least three different displaying positions are located on a same horizontal line of the stereoscopic display, and the horizontal line is substantially parallel to an arrangement direction of the first viewing zone and the second viewing zone.

62. The computer program product according to claim 46, wherein at least two of the at least three different displaying positions are located on different horizontal lines of the stereoscopic display, the horizontal lines are substantially parallel to an arrangement direction of the first viewing zone and the second viewing zone, the at least three different displaying positions are respectively located on different vertical lines of the stereoscopic display, and the vertical lines are substantially perpendicular to the arrangement direction of the first viewing zone and the second viewing zone.

63. The computer program product according to claim 46, wherein the fourth instructions comprise:
instructions configured to determine the optimal viewing position according to a position corresponding to an extreme value in the set of total comprehensive distribution data.

64. The computer program product according to claim 63, wherein the instructions configured to determine the optimal viewing position according to the position corresponding to the extreme value in the set of total comprehensive distribution data comprise instructions configured to select a midpoint position of the position where the values corresponding to the light intensity values in the at least three sets of first view light intensity distribution data and corresponding to the extreme value in the set of total comprehensive distribution data are located and the position where the values corresponding to the light intensity values in the at least three sets of second view light intensity distribution data and corresponding to the extreme value in the set of total comprehensive distribution data are located as the optimal viewing position, wherein the optimal viewing position corresponds to a midpoint position between a user's eyes.

65. The computer program product according to claim 63, wherein the extreme value is an absolute maximum value.

66. The computer program product according to claim 63, further comprising:
instructions configured to serve a perpendicular distance between the optimal viewing position and the stereoscopic display as an optimal viewing distance.

67. The computer program product according to claim 46, further comprising:
instructions configured to determine an optimal viewing distance range according to design parameters of the stereoscopic display, wherein the positions where the values are located fall within the optimal viewing distance range.
